(19) United States
(12) Patent Application Publication
(10) Pub. No.: US 2007/0088600 A1
(43) Pub. Date: Apr. 19, 2007

(54) Database and information software application for managing, tracking and disseminating product specifications and product sample analytical data in a petroleum refining, storage and transportation operation

(75) Inventors: Vince A. Lichtinger, Findlay, OH (US); Judy L. Dlab, Findlay, OH (US); Doug Rogers, Bluffton, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: Marathon Petroleum LLC

(21) Appl. No.: 11/253,908

(22) Filed: Oct. 19, 2005

(51) Int. Cl. G06F 17/30

(52) U.S. Cl. 705/10

(57) ABSTRACT

A centralized database system used for storing, tracking and disseminating product specification and sample analysis data for a petroleum refining and distribution operation.

### TECHNICAL FIELD OF THE INVENTION

This invention is a centralized database software application used for storing, tracking and disseminating product specification and sample analysis data for a petroleum refining operation.

### BACKGROUND OF THE INVENTION

Product specification data for petroleum products such as gasoline, diesel fuel and asphalt has to be shared amongst many parties in a large refining and distribution operation. If specifications for a given product change due to regulatory, seasonal or other factors, the changes need to be communicated to the refineries that refine the products as well as product traders and Marketing personnel. Information such as specification sheets must also be updated. In addition to a system wide method to disseminate specification changes, an enterprise wide computerized system for viewing product specification anomalies at various locations is also helpful in providing real-time information to any parties affected.

Prior to this invention petroleum refining companies with multiple refineries utilized individual, decentralized databases at each refinery to track product specifications, inventory, and sampling data. Product specification changes had to be disseminated and coordinated on a per refinery basis and specifications for products in inventory were not always accessible to company personnel and retailers in a consistent format or manner. This invention is an enterprise-wide database network application for disseminating and monitoring product specifications throughout a major refining operation.

### SUMMARY OF THE INVENTION

Product standards/specifications for petroleum products produced in refining operations are typically set by a company-wide internal quality control group. Petroleum product specifications are subject to change for a variety of factors. Seasonal factors may impact how fuels such as gasoline or diesel fuels are blended, regulatory factors may also dictate product specification changes. This invention is a network wide software application system that interfaces with centralized databases that contain product specifications, product sample analysis results and product naming and unit standards. This software application provides a graphical user interface for database input and database report generation and serves as a central repository for all product specification information. The information is accessible by all company locations via a company intranet. In addition to being a central repository for product specification data, this database application also has the capability to automatically notify refineries or other relevant operations when a specification change has occurred, and also when a product sample is found to be outside of specifications at a given facility. In addition, company bulletins both for internal use and for customers may be generated that include up to date, real time information about products and their specifications.

Along with a centralized product specification database, this invention includes an analysis results database component. This is a computerized database that captures data both from laboratory quality control sampling programs and from refinery quality control labs.

By interfacing with the centralized specification database system, this analysis results database application has the capability of analyzing the actual specifications of samples of products in inventory and identifying any products in the system that are off specification. Products not meeting company specification standards may be identified/viewed in a variety of formats via the company's internal computer network (intranet). Computerized product reports may be generated by authorized intranet users in tabular or graphical form and product data may be obtained on a by product basis or on a geographical basis with a mapping component which shows the locations where products are on or off specification throughout the refining and transportation system. By tracking product quality data as derived from sampling throughout the refining and distribution network, the database application can dynamically generate sample reports and “Exception Reports” identifying all off specification products in the network. In addition, refinery “Certificate of Analysis” documentation may be generated by the system. A charting/trending module is also built into the system that captures and displays historical data for particular product specifications and date ranges.

### BRIEF DESCRIPTION OF THE DRAWINGS

FIG. 1 is an overview of the information database application system.

FIG. 2 is a drawing showing the graphical user interface welcome screen of the database application.

FIG. 3 shows the applications product quality map user interface.

FIG. 4 shows the terminal regulatory oversight report selection screen.

FIG. 5 shows a terminal regulatory report example containing sample analysis data compiled from the analysis results and product specifications databases.

FIG. 6 shows a terminal regulatory report example in a spreadsheet format.

FIG. 7 shows the analytical results welcome or report selection screen.

FIG. 8 shows the analytical results screen with a list of applicable samples that the user selected from analytical results sample report selection screen.

FIG. 9 shows an example of an individual sample report containing sample analysis data compiled from the analysis results database.

FIG. 10 shows a sample reports notes screen.

FIG. 11 shows the analytical results exception report selection screen.

FIG. 12 shows a product sample exception report containing sample analysis data compiled from the analysis results database.

FIG. 13 shows the analytical results tabular report selection screen.

FIG. 14 shows an example of a tabular report containing sample analysis data compiled from the analysis results and product specification databases.

FIG. 15 shows the analytical results chart selection screen.

FIG. 16 shows an example of a chart containing sample analysis data compiled from the analysis results and product specifications databases.

FIG. 17 shows the analytical results aging report selection screen.

FIG. 18 shows an example of a sample aging report.

FIG. 19 shows an example of a sample aging report chart.

FIG. 20 shows the product specification database product selection screen.

FIG. 21 shows an example of the top half of a product specifications report with data from the product specifications database.

FIG. 22 shows an example of the bottom half of a product specifications report with data from the product specifications database.

FIG. 23 shows an example of a technical news bulletin selection screen.

FIG. 24 shows an example of a technical news bulletin compiled from the product specification database.

FIG. 25 shows an example of a feedback form.

FIG. 26 shows the product specification database data input screen.

FIG. 27 shows an example of the product specification database “Add Test Method” screen.

FIG. 28 shows an example of the product specification database “Add Customer” screen.

FIG. 29 shows an example of the product specification database “Add SeasonNolatility Class” screen.

FIG. 30 shows an example of a specification change notification email.

FIG. 31 shows an example of a specification list selection screen.

FIG. 32 shows an example of a product specification list.

FIG. 33 shows an example of the customer technical news bulletin modification screen.

FIG. 34 shows an example of a users and groups permissions screen that administrators use to control which users have access to which areas of the application.

FIG. 35 shows the specification database log reporting selection screen.

FIG. 36 shows a compiled database modification log report.

### DETAILED DESCRIPTION OF THE PREFERRED EMBODIMENT(S)

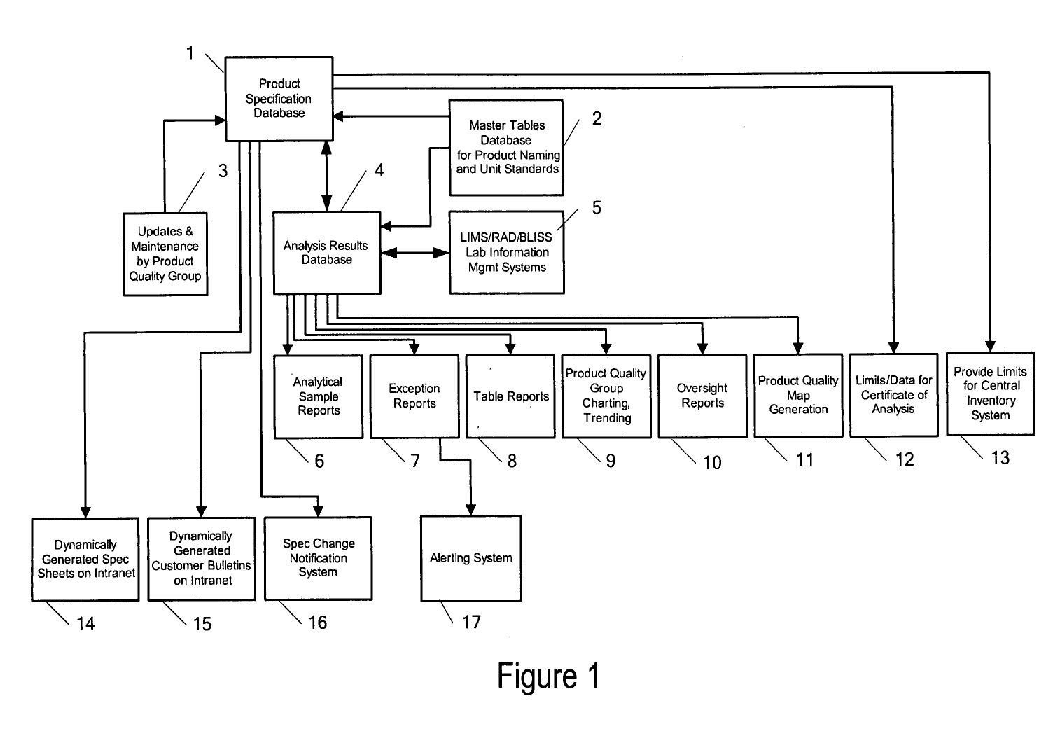

FIG. 1 illustrates an overview of the specification information database system. FIG. 1, Item 1 represents the centralized product specification database which is the main repository for all product specification data. Specification data is included for all products produced by the refinery operation. Product specification parameters vary by product and may include data such as sulfur content, specific gravity, appearance, evaporation points, etc. Limits or ranges for each specification parameter may also be included.

FIG. 1, Item 2 represents a master tables database which is used to provide a common naming and unit scheme to all data. This database contains the master tables that are used throughout the specification database system to provide consistency with the standard names for location, facility, storage unit, commodity, etc.

Database updates are performed as a result of a new product addition, product update, or specification change performed by a company wide product quality group (FIG. 1, Item 3).

FIG. 1, Item 4 represents an analysis results database. This database contains data both from terminal quality oversight sampling programs and from refinery quality control labs. By interfacing with the product specification database (FIG. 1, Item 1) an integrated analytical results application compares actual product data from product laboratory samples to the pre-established limits to identify whether products in inventory are on- or off-specification.

Laboratory information systems (FIG. 1, Item 5) supply data to the analysis results database (FIG. 1, Item 4). Because laboratory information systems used throughout the refining and distribution system may differ in the formats and product identifiers they use, cross-reference tables and applications are used to convert all laboratory information data to a common format with common product codes and names.

Information from the databases described above is accessible to users by starting a computerized server-based software program (or application) that is available through a hyperlink on the company's central intranet. The program allows authorized users to access a variety of reports and data via a graphical user interface. Dynamically generated sample reports are available for any single product sample via the applications user interface (FIG. 1, Item 6). Exception reports (FIG. 1, Item 7) are also available that compare sample data against the product specification database and flag samples with any off-specification parameters. To view information in a tabular format, users may also select table reports (FIG. 1, Item 8) this reporting function allows the user to select a date range and view sample results from selected sources or products.

A charting and trending module (FIG. 1, Item 9) is also available through the analytical results application. Utilizing this functionality, charts can be created using historical product data for a particular product specification and a given date range.

Monthly oversight reports (FIG. 1, Item 10) that satisfy E.P.A. regulations are also available through the analytical results application. These reports replace past reports which were compiled manually. The oversight reports include product data for low sulfur diesel, reformulated gasoline, ethanol and rack oxyblender gasoline.

Product Quality Maps (FIG. 1, Item 11) are also available as an option on the programs user interface. The product quality map is a graphical map showing a geographical area (e.g. Eastern U.S.) with all tank farms, refineries and terminals marked. The user may select a test(s) and time frame to view sample results graphically; the data for these maps is supplied from the analysis results and product specification databases. Color coding is utilized to represent products on or off specification at any given location.

The centralized product specification database (FIG. 1, Item 1) provides limits or specification parameter data to computerized systems used by individual refineries for Certificate of Analysis generation (FIG. 1, Item 12). A Certificate of Analysis is a report generated for a batch of refined product showing the product's applicable characteristics (e.g. sulfur content, etc).

The centralized product specification database also provides product limits or specification data for a company-wide central inventory control system (FIG. 1, Item 13).

Other capabilities of the software application that utilize data from the central product specification database include dynamically generated product specification sheets (FIG. 1, Item 14). These specifications are built dynamically for viewing on the company wide intranet. Customer bulletins (FIG. 1, Item 15) are also generated dynamically and are accessible on a company wide intranet.

Finally, this product specification database system automatically notifies refineries and other applicable parties via electronic mail when a product specification changes. In this way the entire refining network has product specification data information communicated to them at the same time (FIG. 1, Item 16).

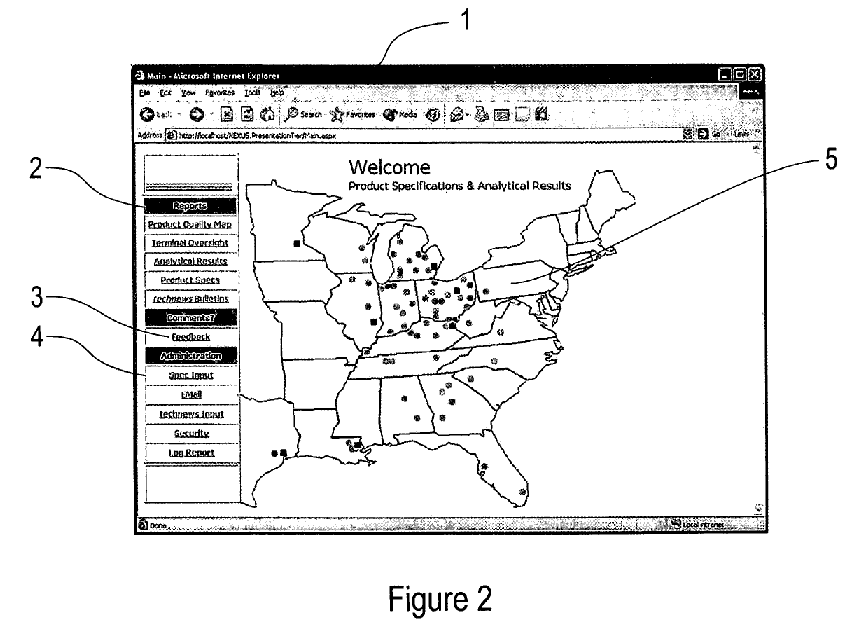

FIG. 2, Item 1 shows the graphical user interface welcome screen of the database application. The application is accessible via an Internet web browser through the company's central intranet. The application is server-based and is accessible by anyone with intranet access and the proper user credentials. User permissions are set by a system administrator. The user interface has hyperlinks that allow the user to access various reports, bulletins and control panels. Various reports may be accessed by clicking on the appropriate link on the interface (FIG. 2, Item 2). There is also a link to send the system administrator feedback or comments about the system (FIG. 2, Item 3). In addition, there is a group of links to access various administrative functions including database specification input (FIG. 2, Item 4). The main section of the interface contains a map of the refinery network area with the facilities that are included in the system marked with different shaped graphics (FIG. 2, Item 5). These graphics represent individual refineries, tank farms and terminals.

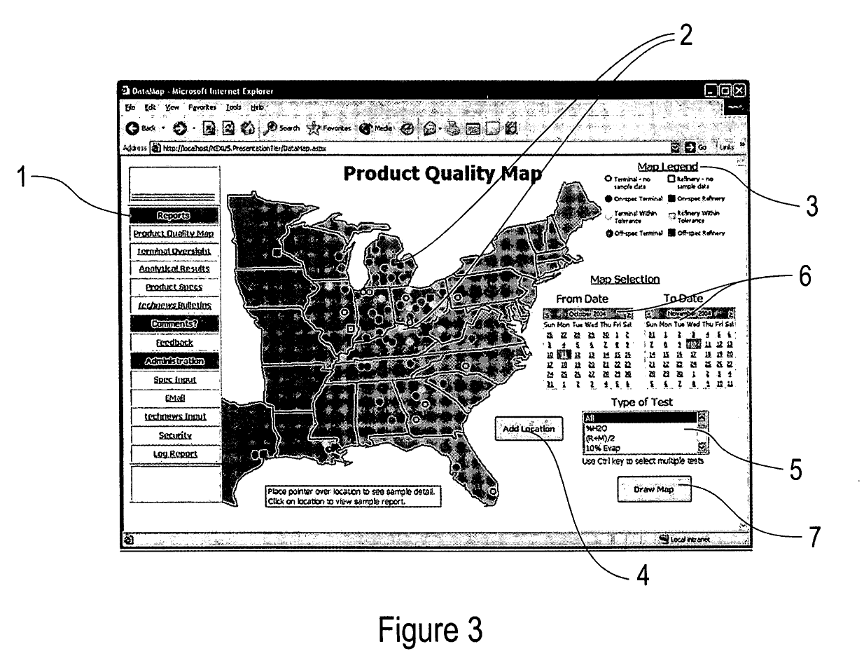

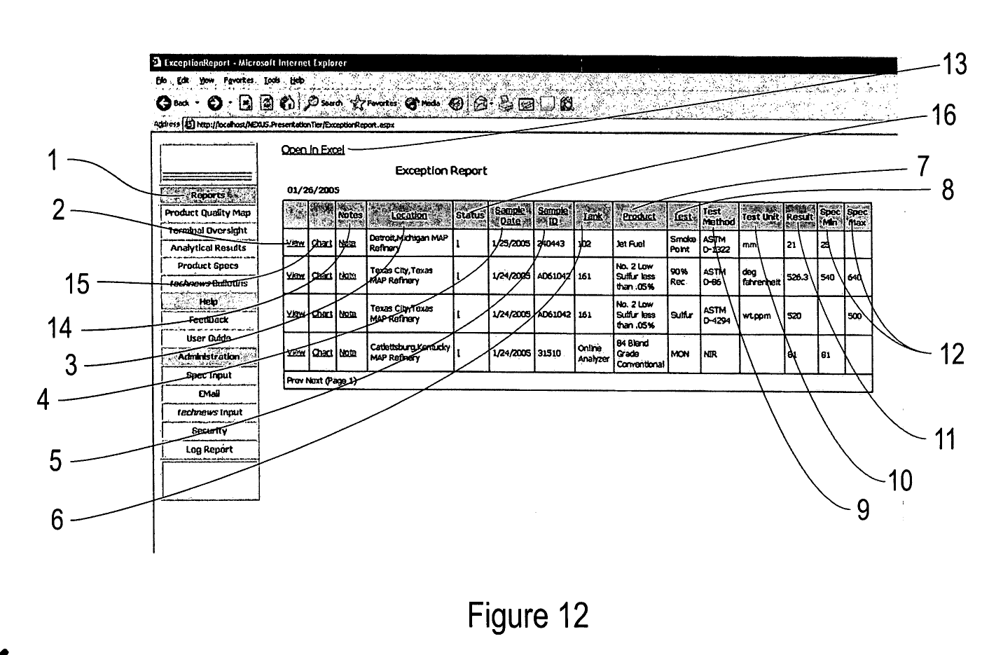

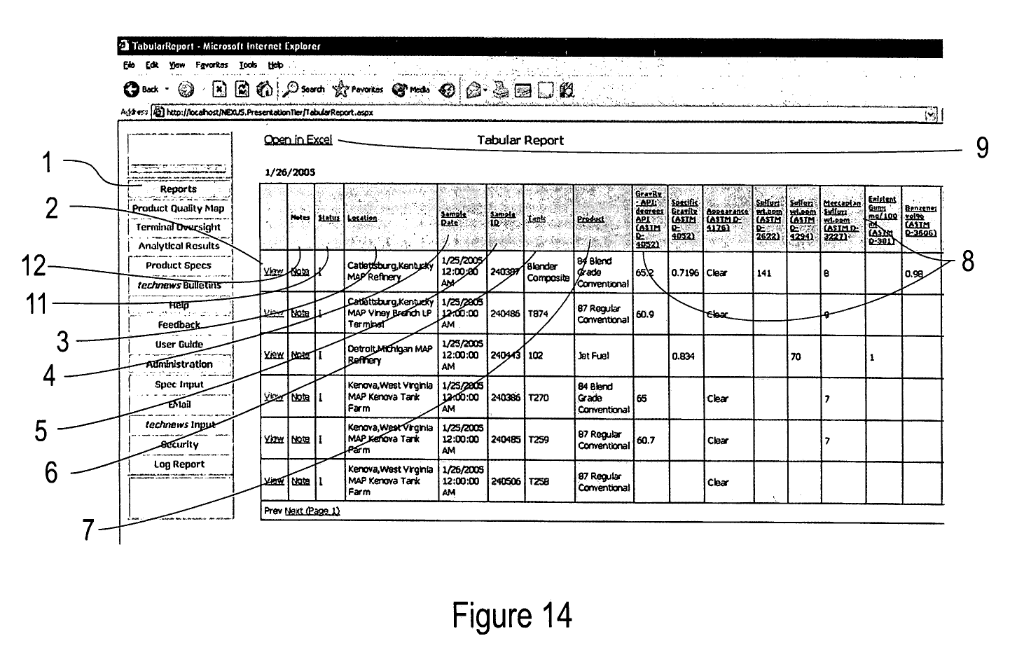

FIG. 3 shows the database application's Product Quality Map. The Product Quality Map is a geographic representation of the refining network area showing all tank farms, terminals and refineries for which data exists in the analysis results database. As with all of the other user interface screens in the system, there is a navigation bar allowing the user to access different areas and functions in the application (FIG. 3, Item 1). The map utilizes color-coded shapes to represent refinery, terminal and tank farm facilities (FIG. 3, Item 2). Facility types are represented by differing shapes such as squares for refineries and circles for terminals. The shapes are also color-coded where different colors represent samples taken at facility locations that are either outside of or off-specification, near specification limits, within or on specification limits, or where no data exists. The various colors and shapes used are described to the user in a map legend section on the interface (FIG. 3, Item 3). For example, facilities represented by a red graphic have sample data that is “off-spec” or outside of the products specifications. Yellow graphics indicate that there is sample data from the facility that is within alerting limits, and green graphics indicate that all samples at the facility are within specification. Blue, or hollow outline graphics indicate that there is no data for the facility. There is a button on the interface which is visible only to users with the correct credentials or permissions labeled “Add Location” (FIG. 3, Item 4). By clicking on this button the user may add a facility onto the map. Users may place their cursor over a location on the map and a small window will appear on their screen listing all off-specification samples or those within tolerance in the underlying data. Included in this window is the location, product, sample date, sample value and specification value. Clicking on a red facility displays the Exception Report (shown in FIG. 12). Clicking on a yellow facility displays a modified Exception Report listing results outside the tolerance limits for the selected location, date range, and test type. Clicking on a green facility displays the Tabular Report (shown in FIG. 14) listing all sample data for the selected location, date range, and test type.

If a user would like to access a graphical view with sample data for a given test (or multiple tests), they first would select the type of test they want to view (FIG. 3, Item 5), then click on a date range. Date ranges are selected by selecting dates on two calendar graphics, one being a start or “From” date and one being an end or “To” date (FIG. 3, Item 6). A new map will be drawn showing only the sample data that matches the test type and date range selected by clicking on the “Draw Map” button (FIG. 3, Item 7).

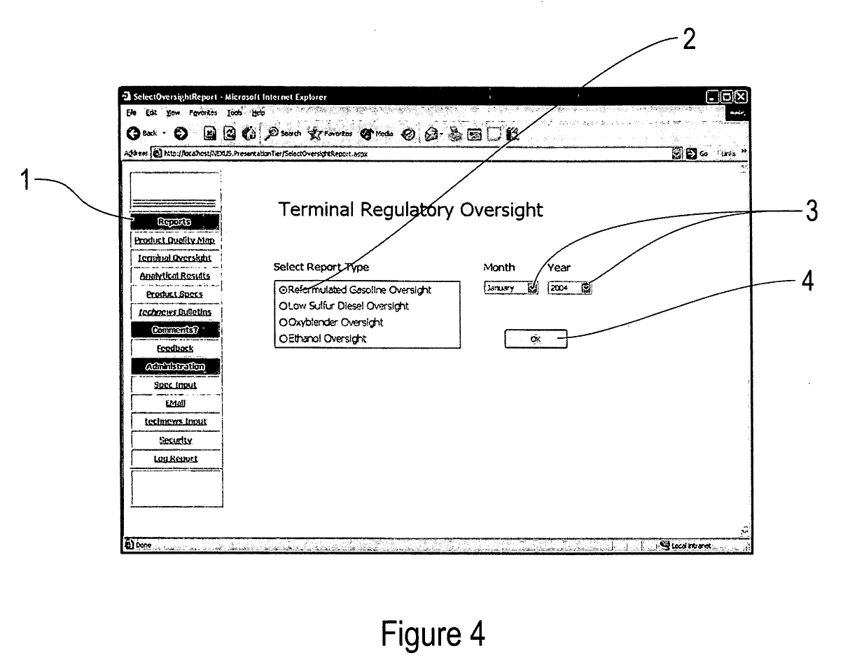

FIG. 4 shows the terminal regulatory oversight welcome screen, users access this screen by clicking on the “Terminal Oversight” link from any screen throughout the application. The terminal regulatory oversight section of the application provides the user with terminal regulatory oversight reports for reformulated gasoline, low-sulfur diesel, oxyblender and ethanol. Terminal Oversight Reports are used to satisfy EPA requirements for an oversight program for regulated products. These reports contain periodic sample data that are compared with product specifications and any off-specification results are automatically flagged for follow-up.

As with all of the other user interface screens in the system, there is a navigation bar on the left side of the screen allowing users to access different areas and functions in the application (FIG. 4, Item 1). After the user has accessed the welcome screen, they may select the report type they would like to view by making a selection in the “Report Type” box (FIG. 4, Item 2). The user may also select a date (month and year) for the time frame which they would like the report to cover (FIG. 4, Item 3). The report is assembled dynamically with analysis data from the analysis results database after the user clicks on the “OK” button on the screen (FIG. 4, Item 4).

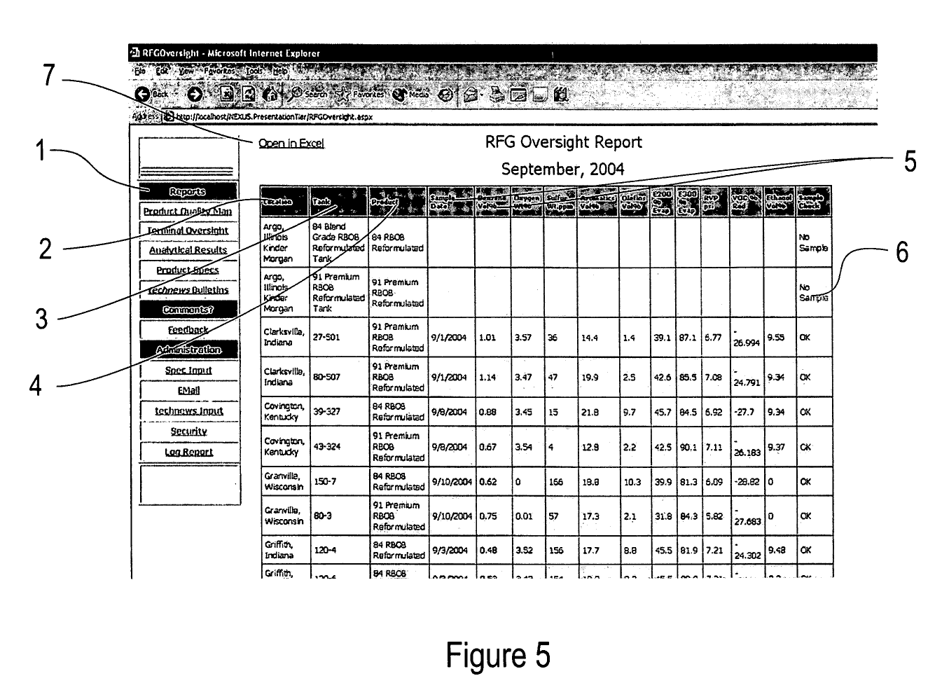

These terminal oversight reports are limited to specific locations, products and tests. Monthly data may be viewed in the reports for a previous time frame from the current date (for example, 84 months). FIG. 5 shows an example of a terminal oversight report for reformulated gasoline. On the left side of the reporting screen is the application universal navigation bar (FIG. 5, Item 1). The data is displayed in a table with table rows for each location and table columns for various information such as location (FIG. 5, Item 2), tank (FIG. 5, Item 3), product (FIG. 5, Item 4) and columns for applicable product data such as sample date, sulfur ppm, etc (FIG. 5, Item 5). If no sample data is available for a given location “No Sample” appears in the last column of the report (FIG. 5, Item 6). Any samples that are off-specification show up in a bold font and red in color to make them noticeable at a glance on the report. If the user wants the data to be in a spreadsheet format they may click on an “Open In Excel” link (FIG. 5, Item 7) and the report will open in a Microsoft Excel spreadsheet format.

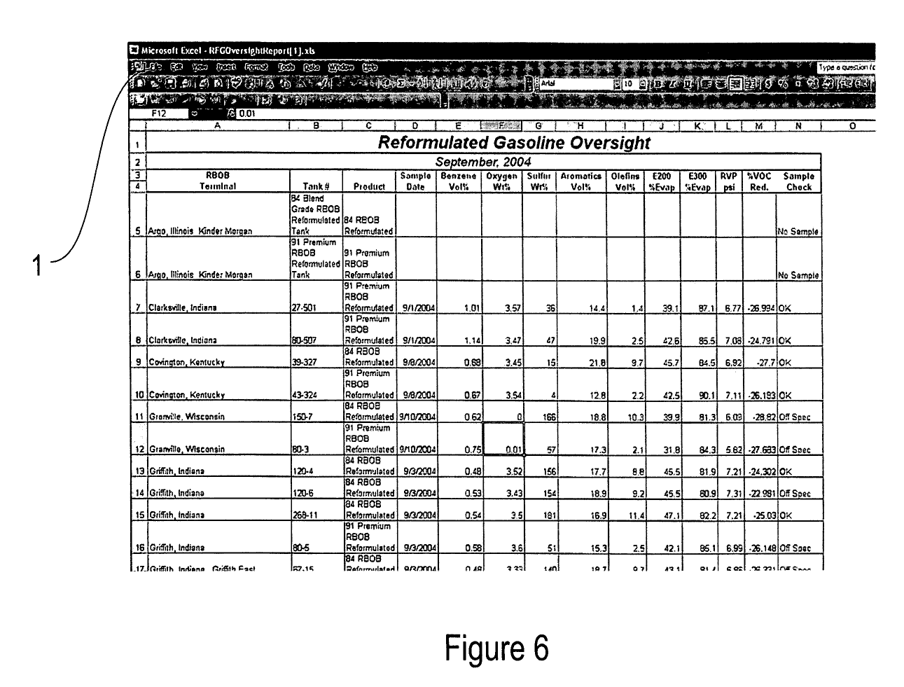

FIG. 6 shows an example of the terminal oversight report in the Microsoft Excel spreadsheet format. In this format, the data is contained in a standard Microsoft Excel spreadsheet with all of the typical spreadsheet functionality included in the standard spreadsheet menu bar (FIG. 6, Item 1).

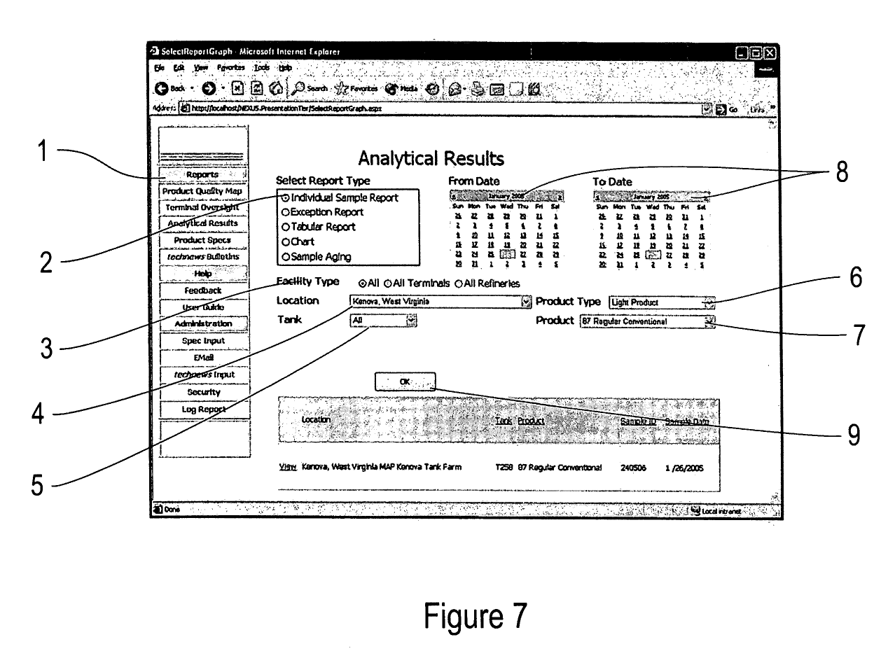

FIG. 7 shows the analytical results reporting welcome or report selection screen. This screen is accessible by clicking on the “Analytical Results” navigation link in the navigation bar on any screen throughout the software application (FIG. 7, Item 1). The user may select a number of different types of reports that are dynamically created from the central analysis results database. Reports available include individual sample reports, exception reports, tabular reports, charts, or sample aging reports. The user selects the type of report needed from the “Select Report Type” box on the welcome screen (FIG. 7, Item 2). For an individual sample report for example, the user must also select a sample date range using the calendars on the interface to make their date period “to” and “from” selections (FIG. 7, Item 8). In addition, the user must select a facility type (FIG. 7, Item 3), a location from the “Location” drop down list (FIG. 7, Item 4), and a tank from the “Tank” drop down list (FIG. 7, Item 5). Both the “Location” and “Tank” drop down boxes are populated only with the locations and tanks for which sample data is available. The user must also select a product type from the “Product Type” drop down list (FIG. 7, Item 6) and a product from the “Product” drop down list (FIG. 7, Item 7). Product types may be items such as asphalt, LPG, specialty products, light products, etc. Products refer to individual products that are part of the selected product type group, for example Regular Conventional Gasoline would be part of the Light Product group. After making their selections from the choices described above, the user then clicks an “OK” button (FIG. 7, Item 9) on the interface to dynamically compile the report with sample analysis data from the analysis results database.

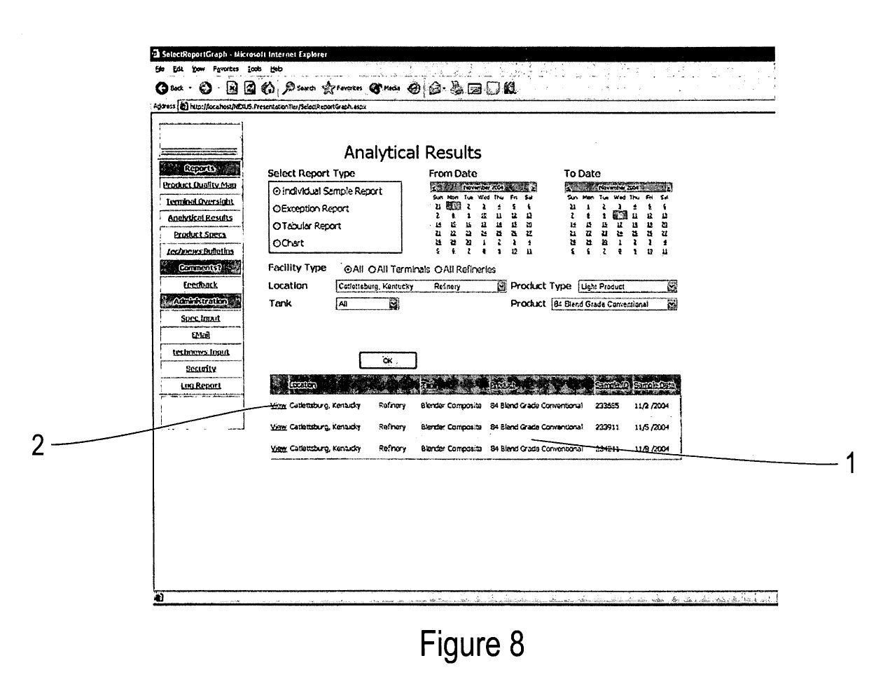

FIG. 8 shows the analytical results screen with the list of applicable samples that the user selected from the reports selection screen in FIG. 7. On the left side of the selection screen is the application universal navigation bar (FIG. 7, Item 1). A table of results appears at the bottom of the screen (FIG. 8, Item 1) with the data for the location, facility type, product type, product and tank that was selected on the previous screen. The user may then click on one of the view hyperlinks in the table (FIG. 8, Item 2) to view a tabular individual sample report.

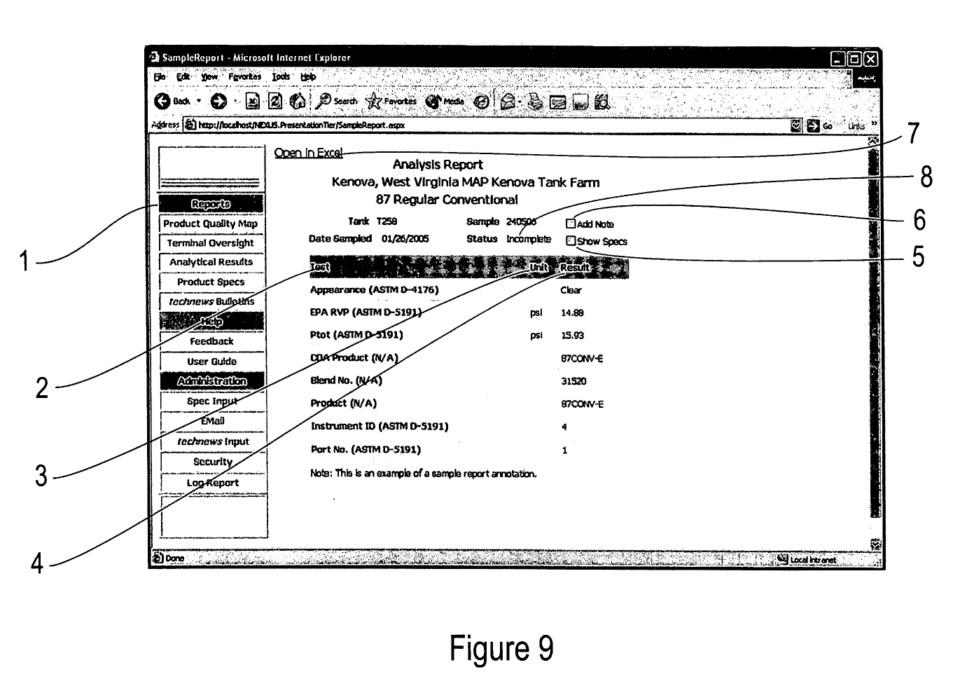

FIG. 9 shows an example of an individual sample report. On the left side of the sample report interface is the applications standard navigation bar (FIG. 9, Item 1). Data for each test performed on the sample appears in a table. There are columns in the table that display the analytical tests run on the sample including the test method (FIG. 9, Item 2). The applicable units of measure for the particular test (FIG. 9, Item 3), and the results of the performed test (FIG. 9, Item 4). There is a “Show Specs” check box at the top of the table (FIG. 9, Item 5). When checked, additional columns appear on the right side of the table that show the product specification ranges (minimum and maximum values). There is also an “Add Note” check box (FIG. 9, Item 6) which when checked allows the user with proper security to add or modify a note regarding the specific sample. At the top of the report is a “Status” indicator (FIG. 9, Item 8) which shows either “complete” or “incomplete” indicating whether or not the sample analysis is complete. As with other reports in the system, there is a link (FIG. 9, Item 7) that when clicked displays the data in Microsoft Excel spreadsheet format.

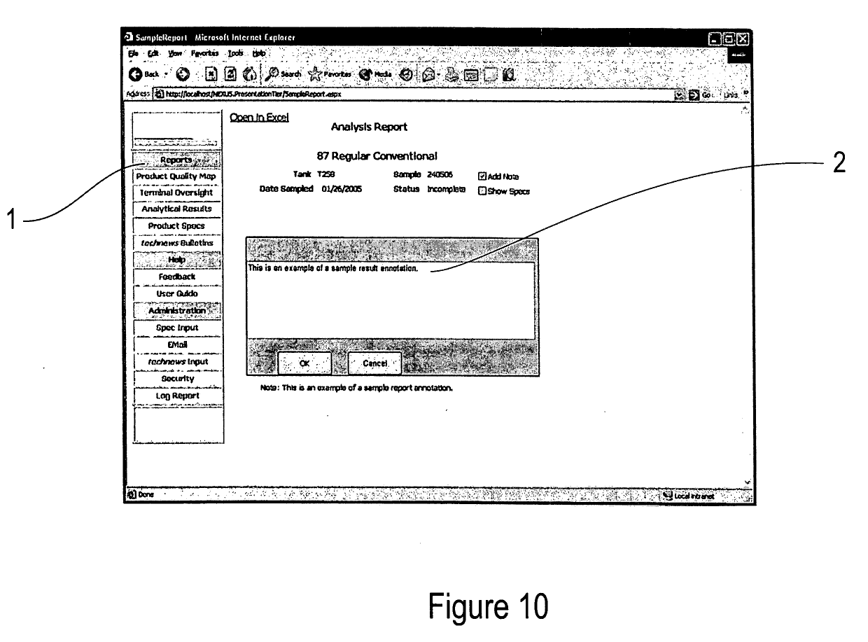

FIG. 10 shows an example of the sample “Notes” screen. When the user clicks the “Notes” check box on the individual sample report, this notes screen appears and allows the user to add a new note or modify an existing note. Notes are used if additional information needs to be added to this database system regarding a specific sample. On the left side of the notes interface is the applications navigation bar (FIG. 10, Item 1). At the center of the notes screen is a text box where text notes may be added or modified (FIG. 10, Item 2). Below the notes text box are “ok” and “cancel” buttons that may be clicked to either save or cancel the note that has been entered.

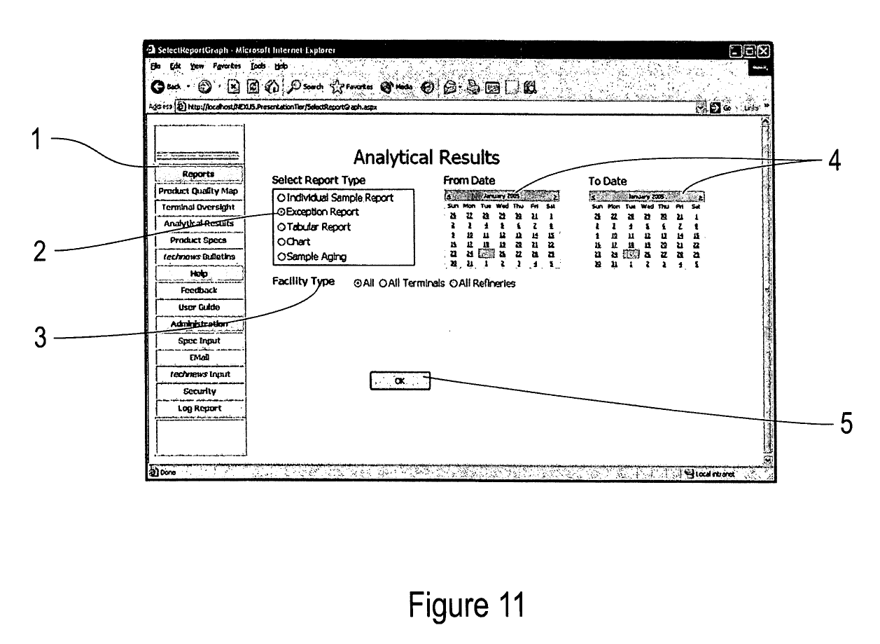

Exception reports, which are reports showing products that were sampled and found to be outside of or off-specification are also available in the database application. By clicking on the “Analytical Results” link on any screen in the application the analytical results welcome or selection screen appears. FIG. 11 shows the analytical results sample screen. On the left side of the interface is the applications navigation bar (FIG. 11, Item 1). The user selects a product type from the choices in the “Select Report Type” box (FIG. 11, Item 2). When “Exception Report” is selected, the user is required to select a facility type (FIG. 11, Item 3) and a date range from the calendars on the interface (FIG. 11, Item 4). After the user has made the required choices, clicking on the “OK” button at the bottom of the interface (FIG. 11, Item 5) dynamically creates the exception report by pulling data from the analysis results database.

FIG. 12 shows an exception report. On the left side of the reporting screen is the application universal navigation bar (FIG. 12, Item 1). In the report table are rows of data, with a row for each location with exceptions, and in each row is a “View” hyperlink (FIG. 12, Item 2) that may be clicked on to view a full sample report for the applicable sample. The columns in the exception report include a column for the facility location (FIG. 12, Item 3), the sample date (FIG. 12, Item 4), the sample ID number (FIG. 12, Item 5), the tank which the off-spec product is in (FIG. 12, Item 6), the product (FIG. 12, Item 7), the test run on the sample with the exception (FIG. 12, Item 8), the test method used (FIG. 12, Item 9), the applicable test unit (FIG. 12, Item 10), the test result (FIG. 12, Item 11) and the acceptable test specification minimum and maximum ranges (FIG. 12, Item 12). The report columns also include a “Chart” column (FIG. 12, Item 15) which contains hyperlinks that may be clicked on to show a chart with trends for a specific sample. There is also a “Notes” column (FIG. 12, Item 14) which contains hyperlinks that may be clicked on to show any notes on any existing sample or to add or modify notes with the proper security. In addition, there is a column labeled “Status” (FIG. 12, Item 16) which contains either an “I” or “C” designating either incomplete or complete sample analysis. As with other tabular reports in the system, this exception report is available to the user in the Microsoft Excel spreadsheet format by clicking on the “Open in Excel” hyperlink at the top of the report (FIG. 12, Item 13).

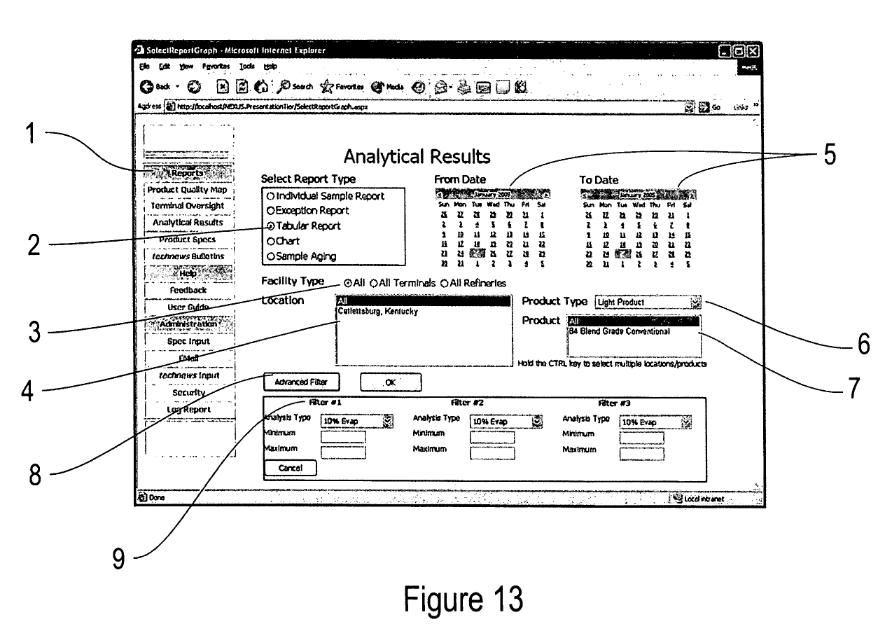

Tabular reports for products may also be viewed through the system. FIG. 13 shows the tabular report data selection screen. This screen is accessed by clicking on the “Analytical Results” hyperlink from any screen in the application (FIG. 13, Item 1). A tabular report can display sample information from a plurality of location types, locations, product types and products. The user also may apply data filters to their selection choices. When a user selects “Tabular Report” from the “Select Report Type” selection box (FIG. 13, Item 2), additional report criteria is required. Facility type (FIG. 13, Item 3), Location (FIG. 13, Item 4), Date Range (FIG. 13, Item 5), Product Type (FIG. 13, Item 6) and Product (FIG. 13, Item 7) must all be selected. By clicking on the “Advanced Filter” button (FIG. 13, Item 8), up to three different filters may be applied to the report. Report filters (FIG. 13, Item 9) allow the user to restrict their data to only show specific types of sample analyses. In addition to selecting the type of analysis, the filter capability also allows the user to input a “Minimum” value to display only sample data greater than or equal to the minimum entered, or a “Maximum” value, which will return data less than or equal to the maximum entered.

FIG. 14 shows an example of a tabular report based upon the report criteria selections that were made on the FIG. 13 selection screen. On the left side of the report screen interface is the application's standard navigation area (FIG. 14, Item 1). The table containing the data has rows for separate locations or products or test types selected. In the first column of the data table there are hyperlinks (FIG. 14, Item 2) that may be clicked on to view the complete sample report for the applicable location, product or test type selected. Additional columns in the table include a “Notes” column (FIG. 14, Item 12) which contains hyperlinks for viewing and/or adding sample notes and a “Status” column (FIG. 14, Item 11) which indicates whether or not sample analysis is completed. The other columns in the data table include a “Location” column (FIG. 14, Item 3), a “Sample Date” column (FIG. 14, Item 4), a “Sample ID” column (FIG. 14, Item 5), a “Tank” column (FIG. 14, Item 6) and a “Product” column (FIG. 14, Item 7). Table columns to the right of the “Product” column (FIG. 14, Item 8) all contain applicable test or analysis results. Test result values that are outside of the specified acceptable ranges, but are within the allowed test tolerance are shown in a bold font and in the color yellow. Test result values that are outside of the specified acceptable ranges or “off-spec” are shown in a bold font and in the color red to make them more easily viewable. As with other reports in the application, the data on the tabular report may be opened in the Microsoft Excel spreadsheet format by clicking on the “Open in Excel” link at the top of the report (FIG. 14, Item 9).

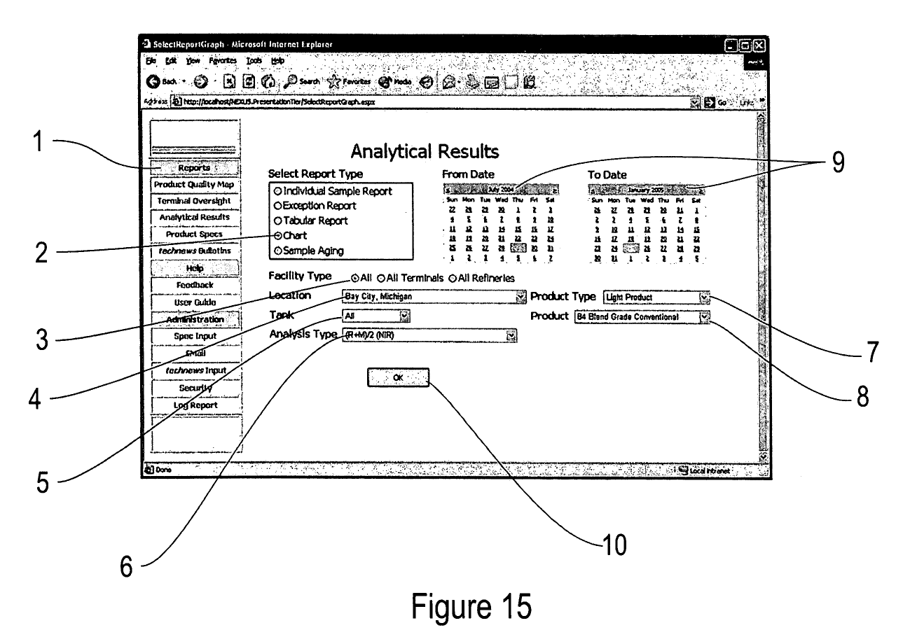

This database software application also has the capability to compile charts that visually graph analysis data over a period of time. FIG. 15 shows the analytical results chart selection screen. As with the other interface screens throughout the application, the application's navigation bar (FIG. 15, item 1) is on the left side of the interface. When a user selects “Chart” from the “Select Report Type” box (FIG. 15, Item 2), other required selection information choices are displayed at the bottom of the interface. Selection choices for a chart type report include facility type (FIG. 15, Item 3), location (FIG. 15, Item 4), tank (FIG. 15, Item 5), analysis type (FIG. 15, Item 6), product type (FIG. 15, Item 7), product (FIG. 15, Item 8) as well as a date range which is selected by clicking “From” and “To” dates (FIG. 15, Item 9). After all of the required selections are made, the user clicks on the “OK” button (FIG. 15, Item 10) at the bottom of the screen to dynamically compile the chart.

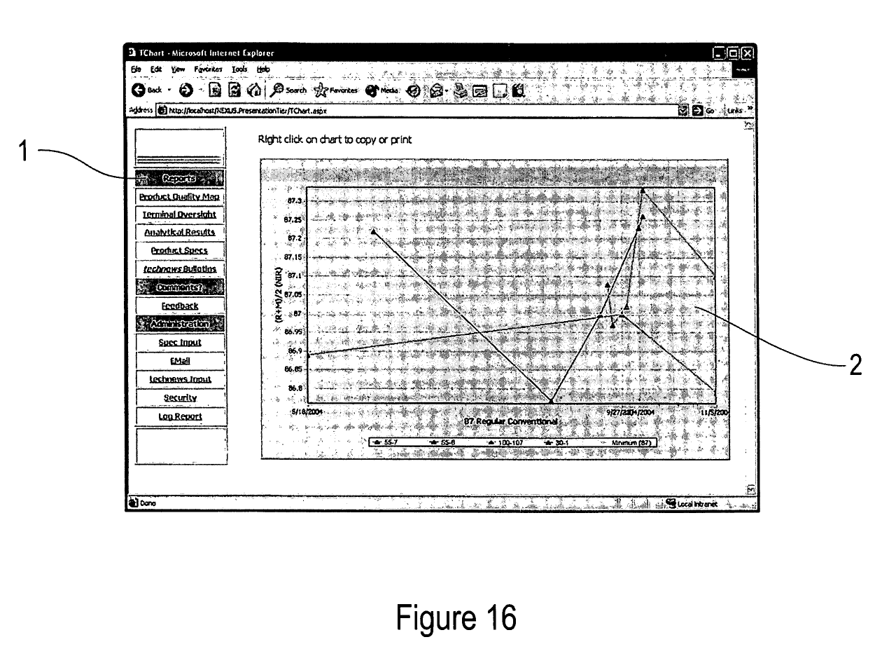

FIG. 16 shows an example of a chart compiled from the selections made on the interface screen described on FIG. 15. The chart screen includes the application's navigation bar (FIG. 16, Item 1) and the chart graphing the sample data the user selected and the applicable specification minimum/maximum (FIG. 16, Item 2). The user can right click with their computer mouse to save the chart to their computer or may copy the chart to their computer's clipboard or may send the chart via electronic mail.

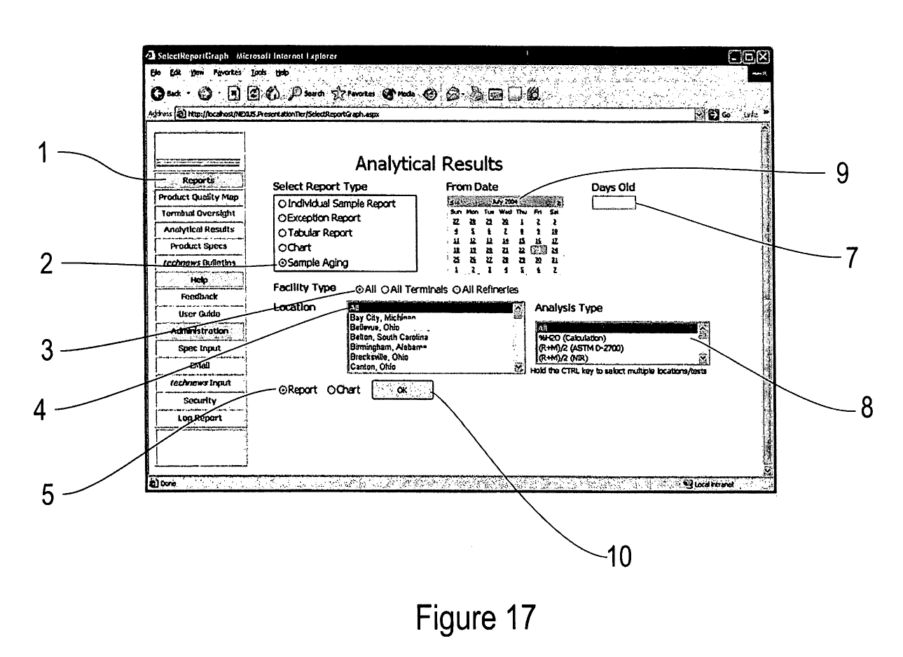

Another capability of the application is to compile a “Sample Aging” report which shows any samples that have an incomplete or pending analysis. FIG. 17 shows the sample aging report selection screen. As with the other interface screens throughout the application, on the left side of the interface is the application's navigation bar (FIG. 17, item 1). When a user selects “Sample Aging” from the “Select Report Type” box (FIG. 17, Item 2), other required selection information choices are displayed at the bottom of the interface. Selection choices for a sample aging report include facility type (FIG. 17, Item 3), location (FIG. 17, Item 4), report type, which may be either “Report” for a tabular format report or “Chart” for a graphic report (FIG. 17, Item 5), analysis type (FIG. 14, Item 8), “From Date” (FIG. 17, Item 9) which is the date the aging report starts and a “Days Old” data entry box (FIG. 17, Item 7) which is where a number of sample aging days is entered. After all of the required selections are made, the user clicks on the “OK” button (FIG. 17, Item 10) at the bottom of the screen to compile the report.

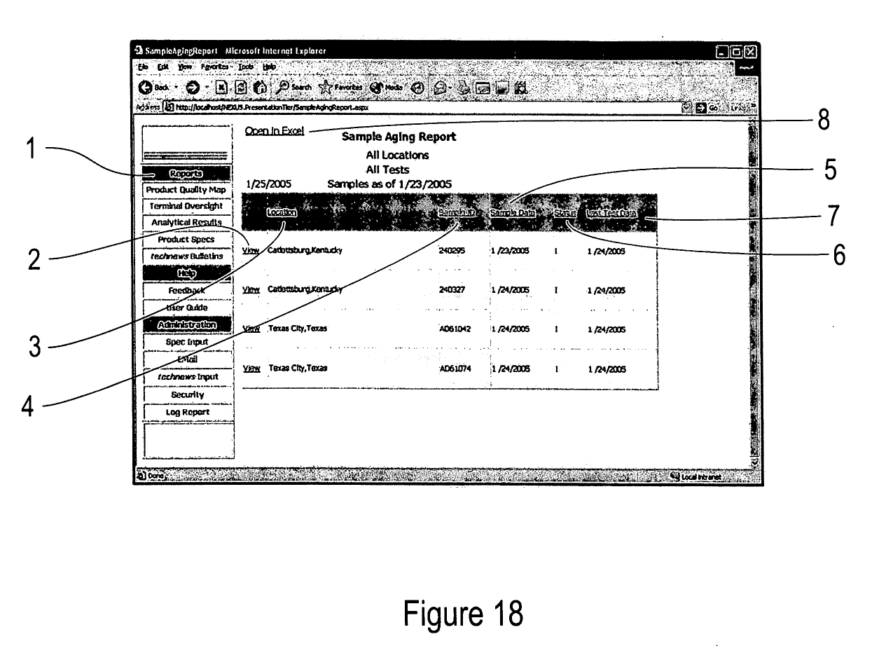

If the User clicks on “Report” on the sample aging report selection screen (FIG. 17), a tabular format aging report is shown as seen in FIG. 18. On the left side of the sample aging report screen is the application navigation bar (FIG. 18, Item 1). In the first column of the report table are “View” hyperlinks (FIG. 18, Item 2) where a user may click to view an individual sample report for each sample. The second column of the report (FIG. 18, Item 3) shows the aging samples location. The third column of the report shows the “Sample ID” number (FIG. 18, Item 4). The next column shows “Sample Date” (FIG. 18, Item 5) followed by columns for “Status” (FIG. 18, Item 6) and “Last Test Date” (FIG. 18, Item 7). The “Status” column will display either an “I” for incomplete analysis or a “C” for complete analysis. As with other reports in the application, the user may click on an “Open in Excel” hyperlink (FIG. 18, Item 8) at the top of the page to open the report in the Microsoft Excel spreadsheet format.

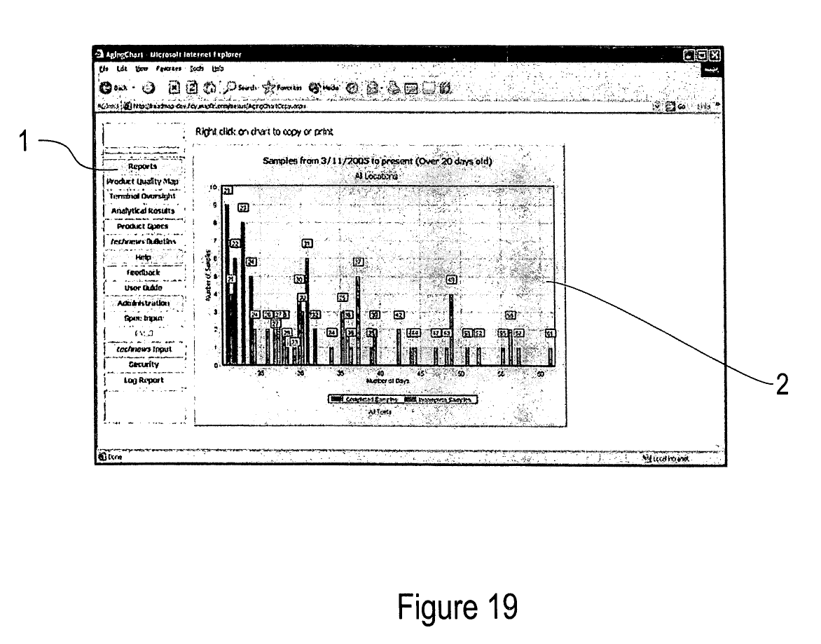

If the user clicks on “Chart” on the sample aging report selection screen (FIG. 17) a chart showing aging samples for the time period selected is compiled and displayed on the screen as shown in FIG. 19. As with other screens in the application, the navigation bar is on the left side of the screen (FIG. 19, Item 1). The number of incomplete and complete samples as well as the number of aging days is plotted on a bar chart in the center of the report (FIG. 19, Item 2). The user may right click on the chart to save, copy, email or print the chart.

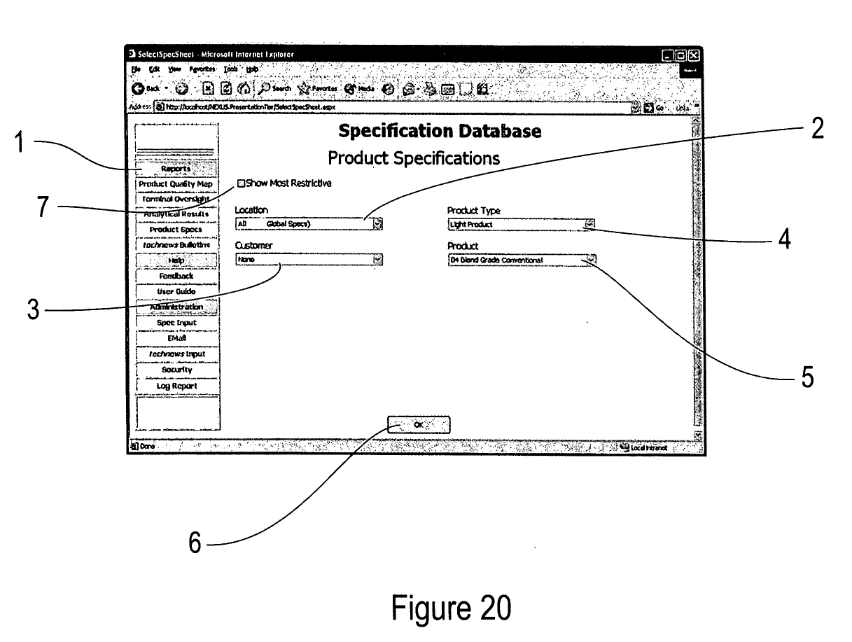

FIG. 20 shows the product specifications selection screen that is accessed by clicking on the “Product Specs” link in the applications navigation bar from any screen throughout the system (FIG. 20, Item 1). The product specification selection screen is a front-end or interface to the central product specification database where specifications may be viewed (see FIG. 1, Item 1). On the product specification selection screen the user makes several selections to access a specification report for the product they wish to view. User selections include “Location” (FIG. 20, Item 2). In this drop down box product specification data for a specific location may be selected or the user may choose a “global” or company wide product spec if applicable. Another selection on this screen is the “Customer” selection box (FIG. 20, Item 3). This selection box contains specific customer names that have custom product specifications. There is a “Product Type” selection box (FIG. 20, Item 4) which contains broad product categories that limit the number of items in the product list. These categories may include items such as “asphalt”, “LPG”, “specialty product”, “light product”, etc. Finally, there is a “Product” selection box (FIG. 20, Item 5) which includes individual product choices such as “84 conventional gasoline” and other applicable products contained within the product type category selected previously. If the “Show Most Restrictive” box is checked on the screen (FIG. 20, Item 7), the report displays the smallest maximum and largest minimum specifications of the selection. After all of the required selections are made, the user clicks on the “OK” button (FIG. 20, Item 6) to compile a specification report with data from the product specification database.

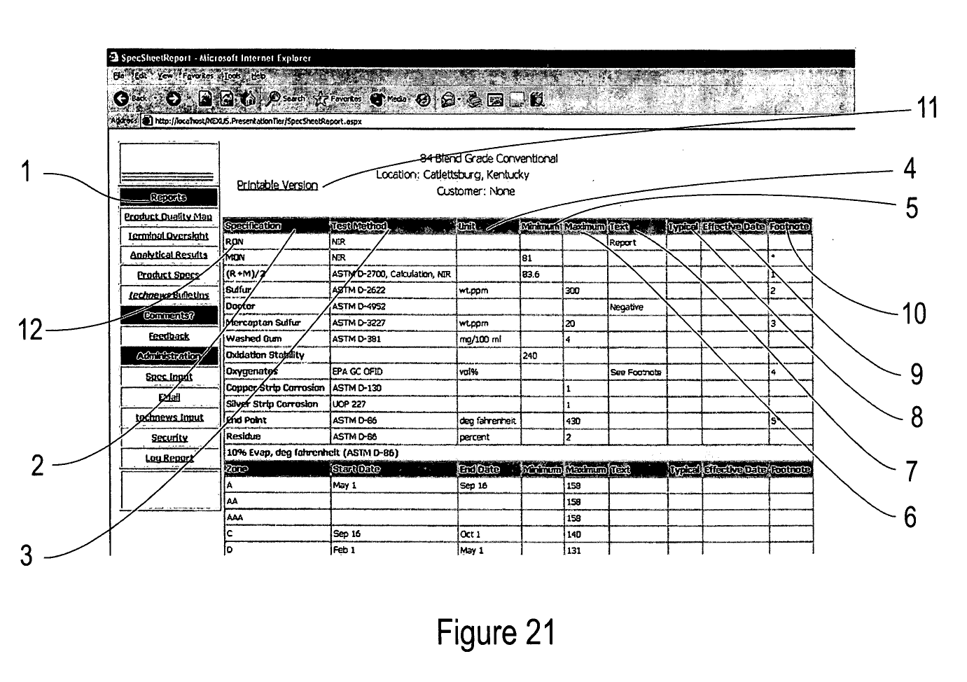

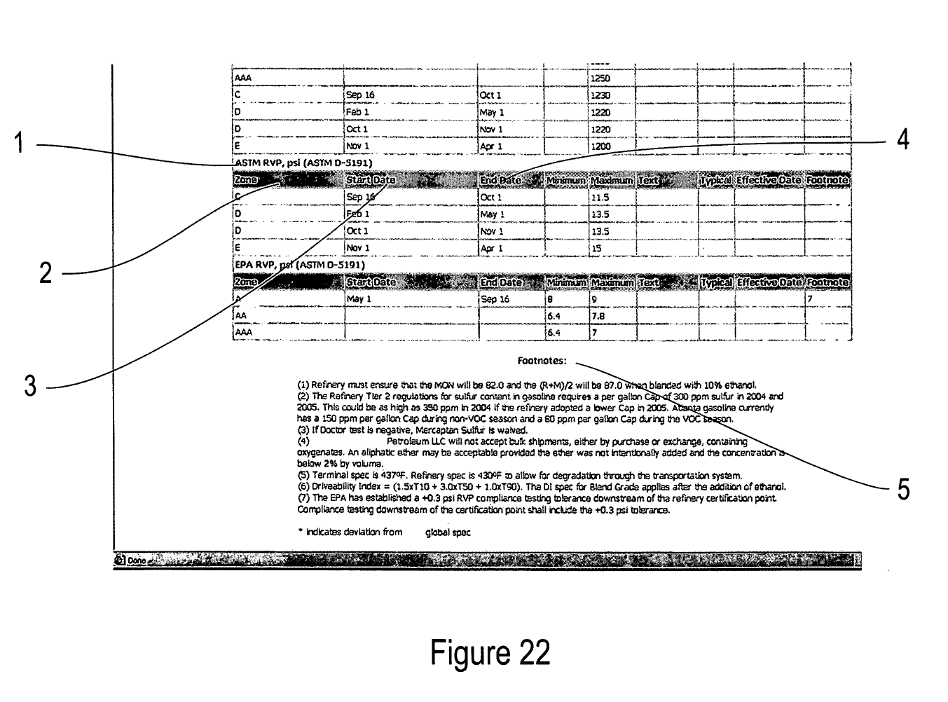

FIG. 21 shows an example of the top half of a product specification report. As with all other screens in the system, the application's navigation bar is on the left side of the screen (FIG. 21, Item 1). The report contains a product specification table with columns of data for “Specification” (FIG. 21, Item 2); “Test Method” (FIG. 21, Item 3); “Unit” which refers to units of measure for the specific specification (FIG. 21, Item 4); “Minimum” (FIG. 21, Item 5) and “Maximum” (FIG. 21, Item 6) which refer to acceptable test ranges; “Text” (FIG. 21, Item 7) which is a column where alphanumeric specifications are noted; “Typical” (FIG. 21, Item 8) which refers to the typical specification range; “Effective Date” (FIG. 21, Item 9) which is the effective date of the specification; and “Footnote” (FIG. 21, Item 10) which refers to the report footnotes (see FIG. 22) applicable to the specification being referenced. Each row of data in the report table contains a product component specification (FIG. 21, Item 12). There is a link at the top of the report page labeled “Printable Version” (FIG. 21, Item 11). Clicking on this link reformats the report to make it fit on a standard sheet of 8.5×11 paper. The user may then print the report by clicking on a “Print” button which will bring up a standard Microsoft Windows print dialog box.

FIG. 22 shows an example of the bottom half of a product specification report. This is a continuation of the report shown in FIG. 21. In the bottom section of the table are specifications for those refined products that are formulated differently depending upon the season and geographic region in which they are used. The seasonal specifications are shown in table rows (FIG. 22, Item 1) with a “Zone” column below which refers to a geographic area (FIG. 22, Item 2). There is a “Start Date” and “End Date” (FIG. 22, Items 3 & 4) shown for each geographic zone showing when the specification is applicable. As with the top half of the report in FIG. 22, there are a number of columns to the right of the start and end dates with minimum and maximum specification value ranges, footnote notations, etc. FIG. 22, Item 5 shows the “Footnotes” section of the report. These footnotes are numbered to correspond with references in the right column of the specification table and contain additional information relevant to the specification within the same table row.

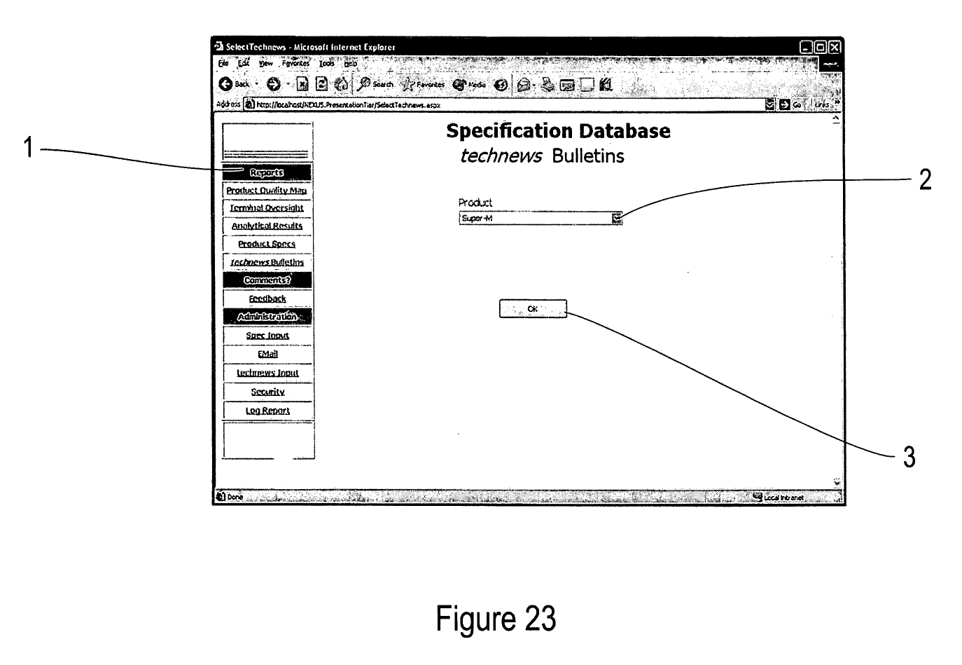

FIG. 23 shows an example of the “Technews” customer bulletin selection screen. Technews bulletins are published for customers and contain product specifications for a specific product. As with other screens in the application, a navigation bar is on the left side of the screen (FIG. 23, Item 1). There is a pull-down list where the user can select which product they would like information for (FIG. 23, Item 2). After a product is selected, the user clicks on an “OK” button at the bottom of the screen (FIG. 23, Item 3) to compile the bulletin for the product selected. The data for this bulletin is dynamically assembled from the product specification database.

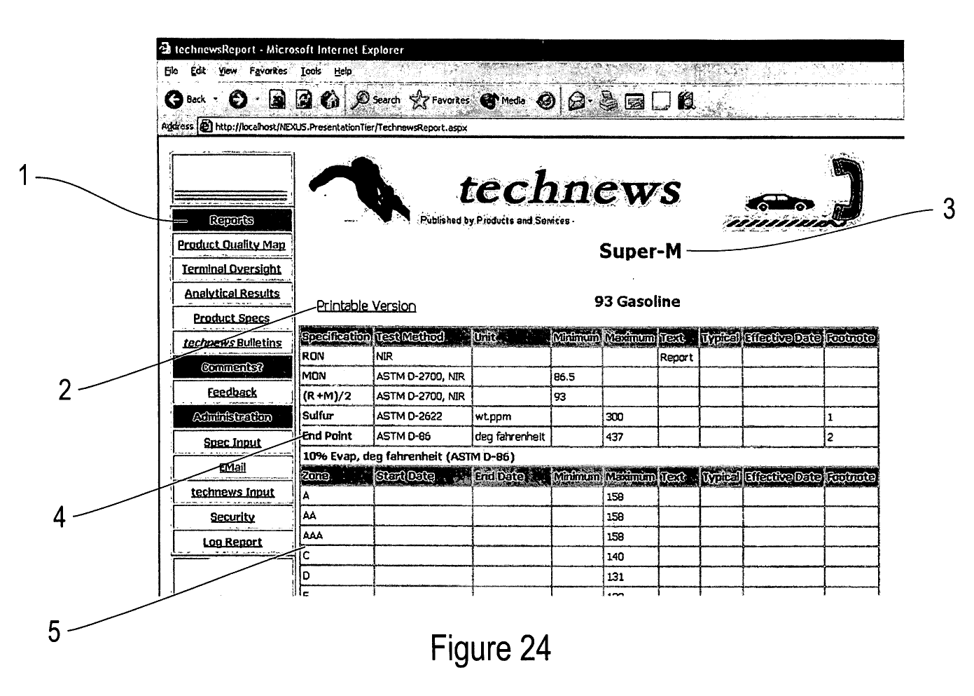

FIG. 24 shows the completed customer bulletin. The bulletin screen has the application's navigation bar on the left side (FIG. 24, Item 1) and a hyperlink that the user may click on for a printable version of the bulletin (FIG. 24, Item 2). The printable version is formatted to fit a standard sheet of paper. At the top of the bulletin, the applicable product is identified (FIG. 24, Item 3). Various technical product attributes are listed in a table format at the center of the bulletin including specifications and test methods (FIG. 24, Item 4). Also, product attributes that vary with geographic zones are shown (FIG. 24, Item 5). These bulletins provide customers with technical data for any product in the product specification database.

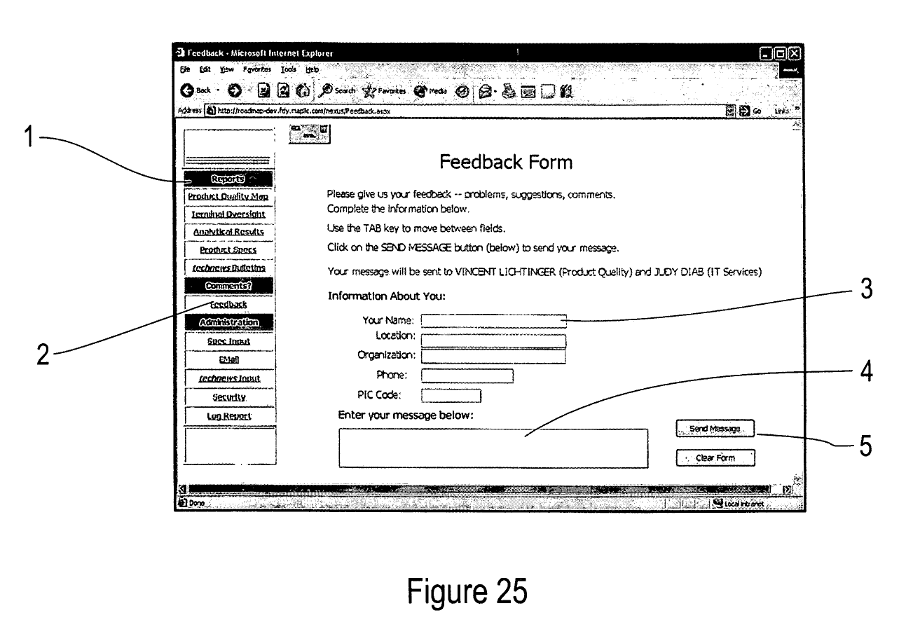

FIG. 25 shows an example of the “Feedback Form” screen. As with the other screens in the application, a navigation bar appears on the left side of the interface (FIG. 25, Item 1). The feedback form is accessible from any screen in the program under the heading called “Comments” (FIG. 25, Item 2). The feedback form is intended for users to send comments, suggestions and other feedback to program administrators. Users first enter their name, location, phone and other contact information into the text boxes on the screen (FIG. 25, Item 3). Next, the user enters the message they would like to send in a message box at the bottom of the screen (FIG. 25, Item 4), then the user clicks on the “Send Message” button (FIG. 25, Item 5) to send their message via electronic mail to the database program administrators.

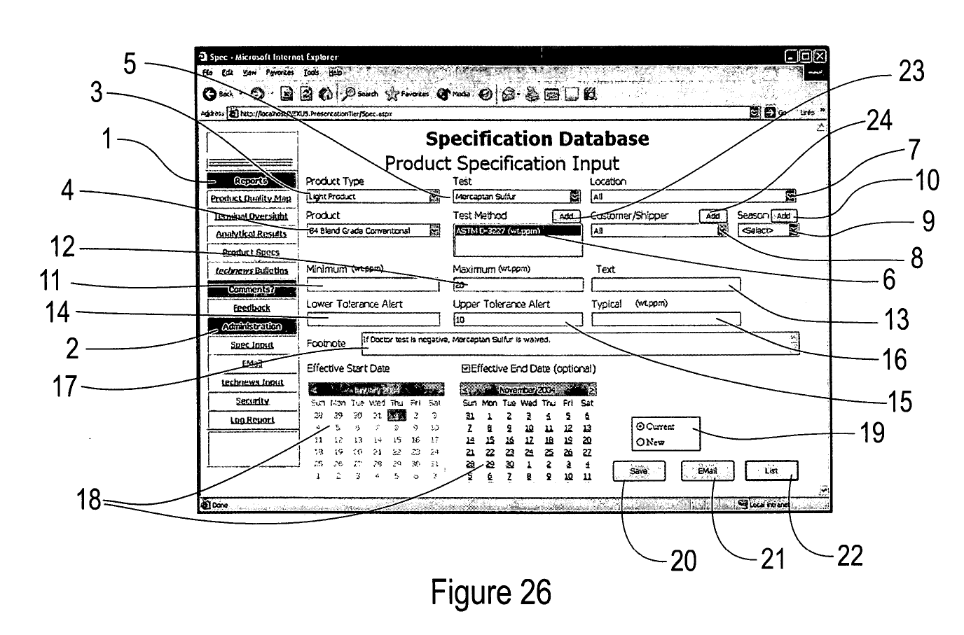

FIG. 26 shows an example of the product specification database data input screen. Only users with designated security “permissions” have access to this area of the software application. On the input screen is the same navigation bar used throughout the application (FIG. 26, Item 1). Under the “Administration” header in the navigation bar (FIG. 26, Item 2) there are links to several administrative functions. These links may not be the same for every user, for example, only a user with the proper permissions for “Specification Input” will see a “Spec Input” link on their page. There are several selection and text boxes for the user to enter data to fill the required fields into the specification database. The “Product Type” pull down box (FIG. 26, Item 3) contains broad product categories such as asphalt, LPG, light product, etc. Making a selection in the product type box narrows the selections in the “Product” selection box (FIG. 26, Item 4) to include only those products in the category selected. In addition, there is a “Test” selection box, (FIG. 26, Item 5) where the specification test is selected such as test for “Mercaptan Sulfur”. The “Test Method” is then entered (FIG. 26, Item 6) such as “ASTM D 3227. Multiple test methods may be entered. There is an “Add” button (FIG. 26, Item 23) at the top of the “Test Method” box that may be clicked to add a new test method to the database. Next, the location for the specification is selected from the “Location” drop down box (FIG. 26, Item 7); a specific location or “all” may be selected. After location, a customer is to be selected from the “Customer” selection box (FIG. 26, Item 8) and a season from the “Season” selection box (FIG. 26, Item 9) in the case of a seasonal specification. Above both the “Customer” and “Season” box are “Add” buttons. If a specific customer or season does not exist in the database, the “Add” buttons (FIG. 26, Item 10 and FIG. 26, Item 24 are used to send a message to the central database administrator to add the desired data.

Data for the selected product, test, test method, location, customer, and season will be displayed in the remaining fields as applicable. In FIG. 26, Items 11 through 16 show an example of applicable data fields. Minimum, maximum or text specification test values may be required (FIG. 26, Items 11, 12, 13). Minimum and maximum refer to numeric value limits for a specific test such as “Maximum 150 ppm”. The field called text would be used for text values for specific tests such as a value of “Clear” or “Amber”. The fields “Lower Tolerance Alert”, “Upper Tolerance Alert”, “Typical”, and “Footnote” (FIG. 26, Items 14, 15, 16, 17) are optional. The tolerance alert fields are numeric and serve as markers in the database system as to when to mark a specification as off-tolerance or off-spec. Effective start and end dates are selected (FIG. 26, Item 18) with the “Effective Start Date” being a required selection and “Effective End Date” optional. There is a “Current” or “New” selection required (FIG. 26, Item 19) where the user selects whether this is a new specification or an edit to a current specification. The “Save” button (FIG. 26, Item 20) is used to save the data to the database. Before the data is saved, the application checks the selection made in the “Current/New” selection box. If “New” is selected and the specification already exists, the selected effective start date is checked against the current specification effective end date to ensure there are no gaps in the data. If the dates are not consistent, a message is displayed asking the user to update the dates as needed to eliminate the time gap. All changes made from this data input screen are saved in a log file for reporting purposes. If a new specification is being entered, an “Email” button will display (FIG. 26, Item 21) which when clicked will send an electronic mail notifying the facilities of the change. There is also a “List” button on the interface (FIG. 26, Item 22) which when clicked will show a sortable list of all product specifications.

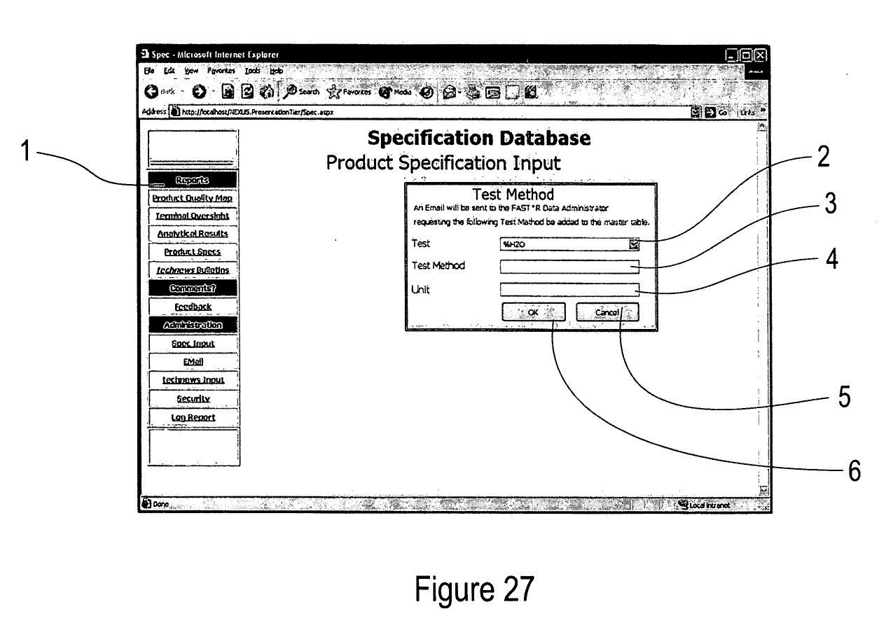

When a user clicks on the test method “Add” button on the product specification input screen (FIG. 26, Item 23), the “Add Test Method” screen depicted in FIG. 27 appears. The application's navigation bar is on the left side of the screen (FIG. 27, Item 1). First, the user selects a test from the “Test” selection box (FIG. 27, Item 2), next a test method is entered into the “Test Method” box (FIG. 27, Item 3), then an appropriate unit of measurement for that test method is entered into the “Unit” box (FIG. 27, Item 4). After the user enters all of the test method data, the user clicks the “OK” button (FIG. 27, Item 6) to send the add request via electronic mail to the database administrator. There is also a “Cancel” button (FIG. 27, Item 5) if the user wants to cancel their entry. All of the sent email requests are saved in a log file.

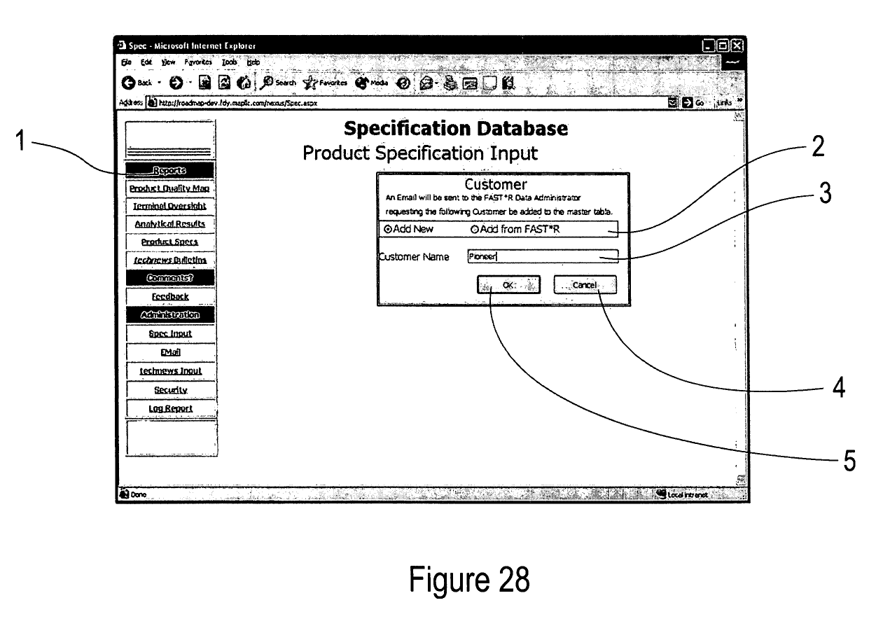

When a user clicks on the customer “Add” button on the product specification input screen (FIG. 26, Item 24), the “Add Customer” screen depicted on FIG. 28 appears. The application's navigation bar is on the left side of the screen (FIG. 28, Item 1). The user first selects whether the customer is a new customer or is a customer that is already existing in the master tables database (FIG. 28, Item 2). If the customer does not already exist in the master tables database, the user enters the customers name into the “Customer Name” box (FIG. 28, Item 3). Finally, the “OK” button (FIG. 28, Item 5) is clicked to send a “Customer Add” request electronic mail to the database administrator in the case that the customer does not exist in the master tables, or to add the customer to the product specifications database. The “Cancel” button is clicked to cancel the request (FIG. 28, Item 4). All of the product specification database changes and sent e-mail requests are saved in a log file.

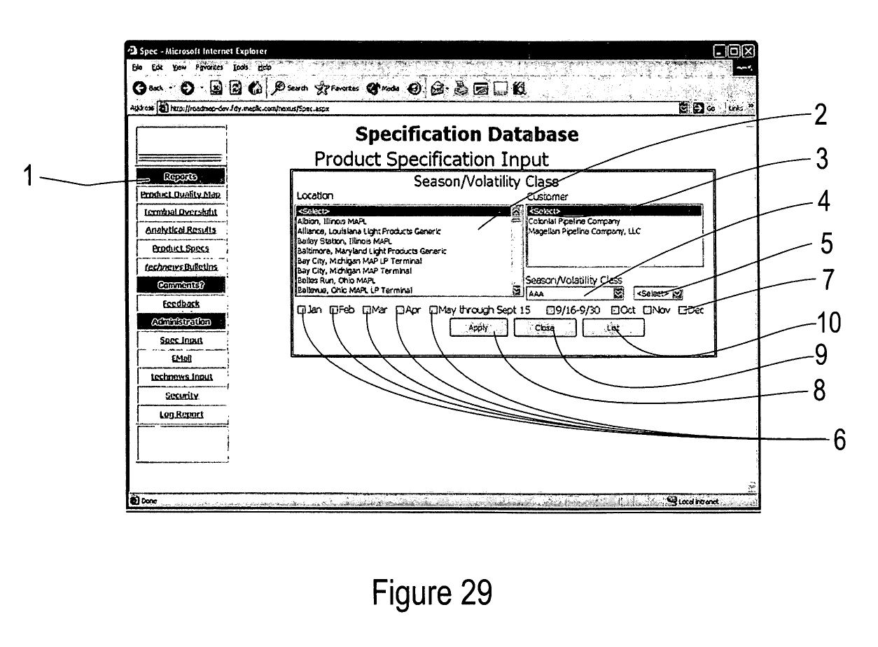

When a user clicks on the season “Add” button on the product specification input screen (FIG. 26, Item 10), the “Add Season” screen depicted in FIG. 29 appears. The application's navigation bar is on the left side of the screen (FIG. 29, Item 1). First, a location is selected from the “Location” list box (FIG. 29, Item 2). This list box is filled with location data from the central database. Next, a customer is selected from the “Customer” list box (FIG. 29, Item 3). The customer data is filled with customers in the product specification database. Multiple values may be selected in either the location or customer list boxes. A single value is selected from the “SeasonNolatility Class” drop down box (FIG. 29, Item 4). This list contains volatility classes such as “A”, “AAA”, “B”, etc. and seasonal codes such as “Winter MW (Midwest)” or “Winter SE (southeast). In addition, a number from a drop down box (FIG. 29, Item 5) adjacent to the “SeasonNolatility Class” drop down box can be selected to append to specific volatility classes. The applicable months or time periods that define the season or volatility class are available as check boxes (including all items between FIG. 29, Items 6-7). The “Apply” button (FIG. 29, Item 8) saves the data displayed on the screen. The “Close” button (FIG. 29, Item 9) closes the screen and the “List” button (FIG. 29, Item 10) displays all seasonal/volatility class data in a sortable table on a new screen. All changes made from this data input screen are saved in a log file for reporting purposes.

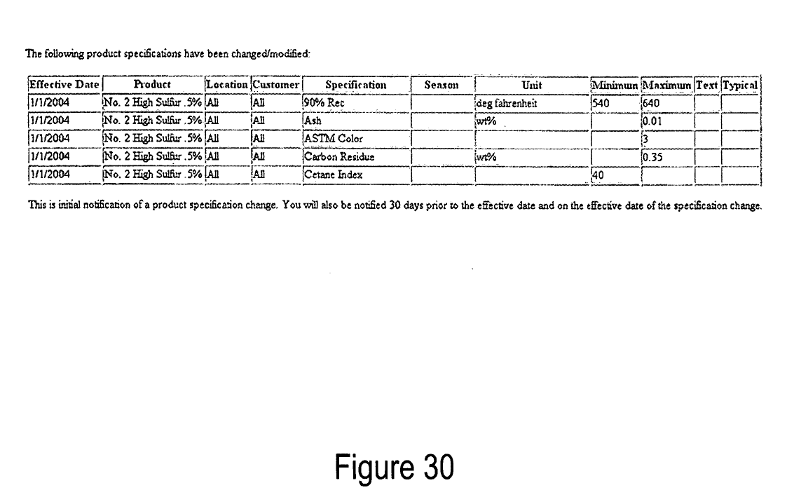

FIG. 30 shows an example of a specification change notification email that is sent to applicable parties when product specifications have been changed. By sending these emails out to all applicable parties as soon as specifications are changed, all facilities throughout the refining network have up-to-date and consistent product specification information. On the Product Specification Input screen shown on FIG. 26, there is an “Email” button (FIG. 26, Item 21) that sends electronic mail notifications to the applicable facilities when product specifications have been changed. When the user clicks on the email button, a dialog box appears on their computer screen asking the user if they would like the specification changes emailed to the applicable locations. FIG. 30 shows an example of the email sent, the email lists all of the specification changes in a table with a row for each change. The rows contain the effective date of the change, the product, location, customer, specification, season, unit, minimum and maximum limit, text value if applicable, and typical value.

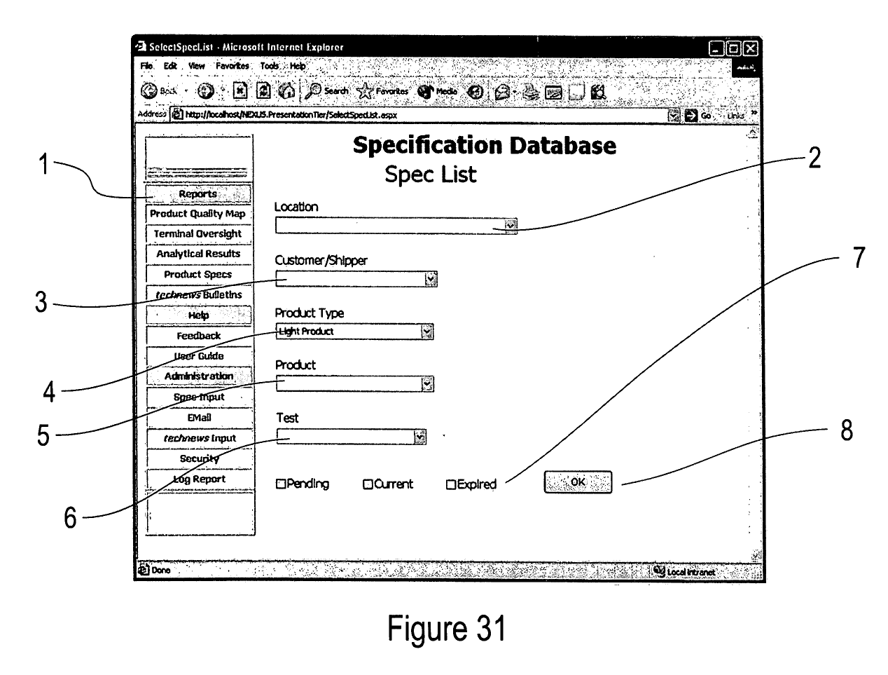

FIG. 31 shows an example of a screen that appears when the user clicks on the “List” button on the “Product Specification Input” screen (FIG. 26, Item 22). On the left of the screen is the application navigation bar (FIG. 31, Item 1). To view a list of product specifications, the user first will select a location from the “Location” drop down list (FIG. 31, Item 2). The user may select an individual location or may select “All” to view specifications for all locations. Other selections include “Customer/Shipper” (FIG. 31, Item 3) to view specifications for a specific customers; “Product Type” (FIG. 31, Item 4); “Product” (FIG. 31, Item 5); and “Test” (FIG. 31, Item 6). In addition, there are check boxes for “Pending”, “Current”, and “Expired” (FIG. 31, Item 7) which the user may select to view past, present or future specifications. An “OK” button (FIG. 31, Item 8) is clicked to compile the specification list.

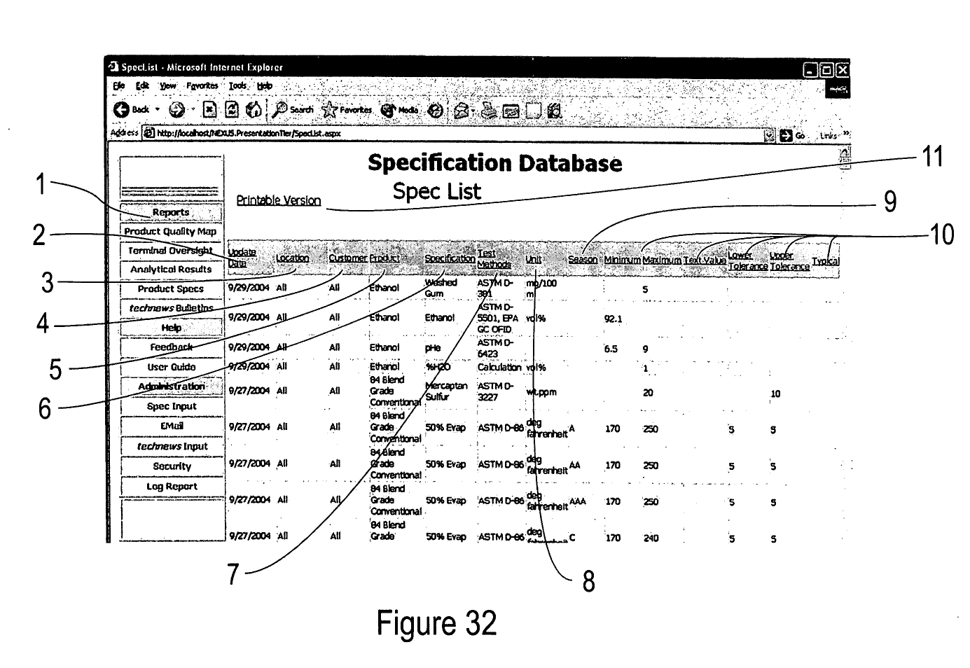

After the selections are made on the product specification list selection screen in FIG. 31, a product specification list screen appears as seen in FIG. 32. The specification list screen has the application navigation bar on the left (FIG. 32, Item 1) and a table containing specification data in the center of the interface. The data table columns include the specification information including “Update Date” (FIG. 32, Item 2), “Location” (FIG. 32, Item 3), “Customer” (FIG. 32, Item 4), “Product” (FIG. 32, Item 5), “Specification” (FIG. 32, Item 6), “Test Method” (FIG. 32, Item 7), “Unit” (FIG. 32, Item 8), “Season” (FIG. 32, Item 9), and applicable specification test values such as minimum/maximum values and tolerances (FIG. 32, Item 10). At the top of the interface is a “Printable Version” hyperlink (FIG. 32, Item 11) which may be clicked to generate a report formatted for printing on 8.5×11 paper.

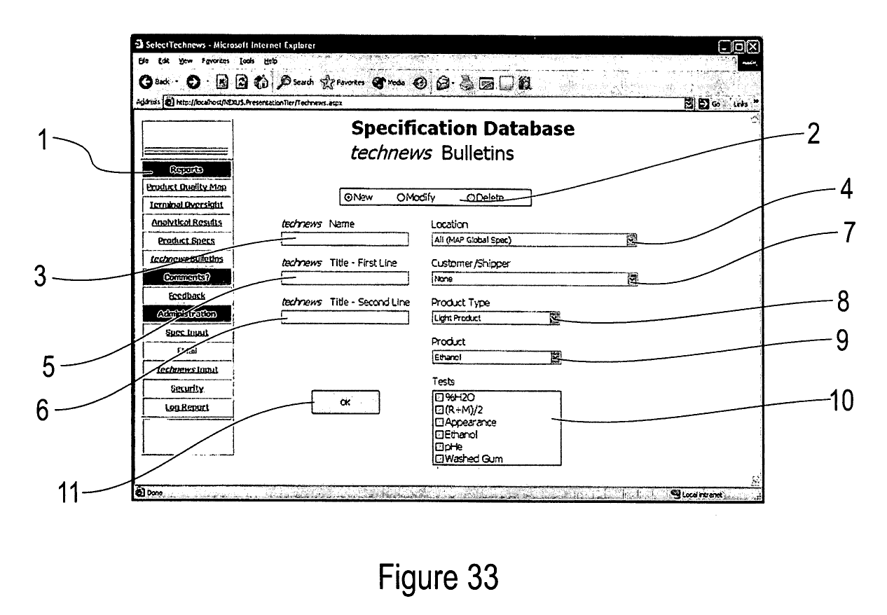

FIG. 33 shows an example of the customer technews bulletin modification screen. FIG. 24 shows a completed technews bulletin with product specification data. The screen in FIG. 33 is a control panel where authorized users can create new or modify technews bulletins. As with other areas of the application, the user must have the proper permissions to access this part of the application. On the left side of the screen is the application's navigation bar (FIG. 33, item 1). The user selects either “New”, “Modify” or “Delete” (FIG. 33, Item 2) depending upon what action they are taking. If “New” is selected, then the “Technews Name” (FIG. 33, Item 3) and “Technews Title” (FIG. 33, Items 5 & 6) must be completed. The “Location” (FIG. 33, Item 4) and “Customer/Shipper” (FIG. 33, Item 7) drop down lists are used to select product specifications specific to a certain customer, shipper and/or location. There is a “Product Type” list (FIG. 33, Item 8) for selecting the product category, then a “Product” list (FIG. 33, Item 9) for selecting the specific product that the bulletin is addressing. All applicable tests available in the specification database for the product selected appear in the “Tests” list box (FIG. 33, Item 10) with check boxes next to each test name. At least one test must be checked.

If “Modify” is selected (FIG. 33, Item 2), the “Technews Name” box (FIG. 33, Item 3) is replaced with a list of all existing technews bulletins, one of which must be selected. The remaining fields are then populated with the corresponding existing data for the bulletin selected and may be modified.

If “Delete” is selected (FIG. 33, item 2), the “Technews Name” box (FIG. 33, Item 3) is replaced with a list of all existing technews bulletins, one of which must be selected. The remaining fields are then populated with the corresponding existing data for the bulletin selected and may not be modified. Clicking on the “OK” button (FIG. 33, Item 11) saves the data on the screen to the specification database. All changes made from this data input screen are saved in a log file for reporting purposes.

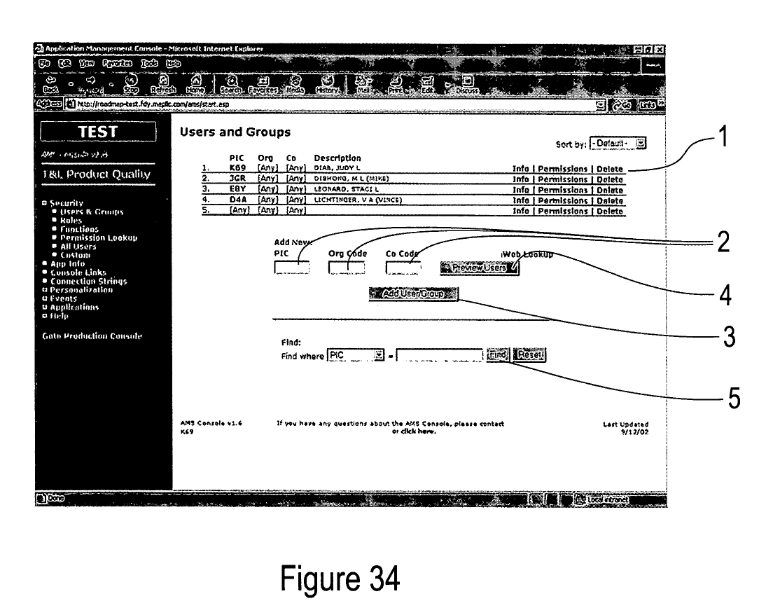

FIG. 34 shows an example of the users and groups permissions screen. Only those users with “Security Manager” designation in the system have access to the permissions screen. On this screen, administrators may set permissions or grant user access to specific areas of the database software application. Authorized users to the system are shown in a table at the center of the screen (FIG. 34, Item 1). On the far right of each row are three hyperlinks, “Info”, “Permissions” and “Delete”. A click on the “Info” link shows information about the person such as login and contact information. The “Permissions” link opens a control console where permissions for the user may be set. Permissions are settings that grant specific users access to specific areas of the application. Different security roles may be set in the permissions area including:
Administration
   Specification & Technews Input
   Send Email
   Input Sample Notes
Administrative Assistant
Email Distribution List
Security Manager

Each of these security roles have access and authorization to different areas and functionality of the database application. There is also a “Delete” hyperlink on each role where users may be deleted. New users may be added by entering their data in the data add text boxes (FIG. 34, Item 2). Entire groups of users can be added by adding an organization code, or a company code. After adding the identification code, clicking on the “Add Users/Groups” button (FIG. 34, Item 3) brings up a dialog box where a user's permissions may be added. There is also a “Preview Users” button (FIG. 34, Item 4) that allows the user to preview user information before adding it to the users and groups list. There is a search or find function at the bottom of the screen where user information may be quickly found by entering their personal identification code and clicking on the “Find” button (FIG. 34, Item 5).

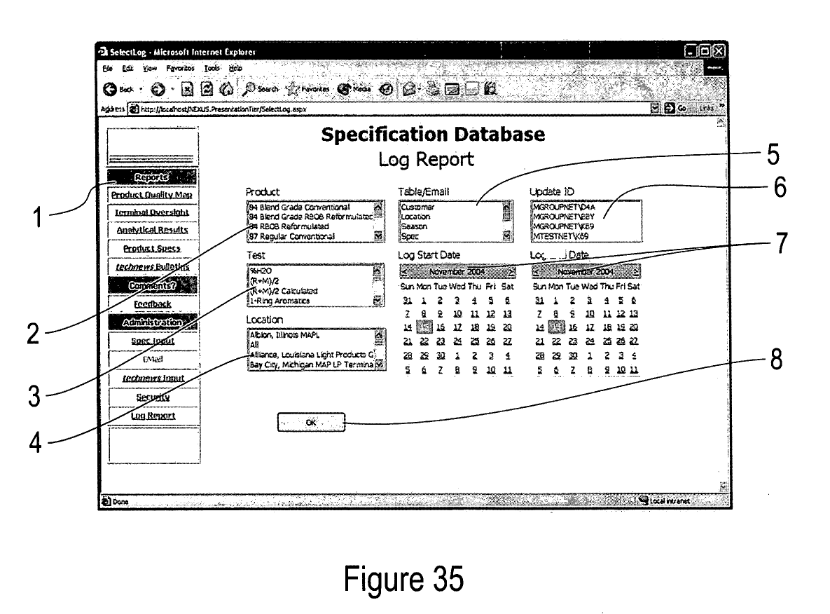

FIG. 35 shows an example of the product specification database log report selection screen. This area of the application is only available to those users that have the “Administration” permission setting in the system. Log reports are reports that show all additions and modifications to the database system. As with other screens in the application, a navigation bar (FIG. 35, Item 1) is on the left side of the screen. The log report selection includes selection choice boxes for “Product” (FIG. 35, Item 2). A single product or multiple products may be selected from this list. The log report will show database modifications for the product(s) selected in this box. There is also a “Test” selection box (FIG. 35, Item 3) where a single or multiple specification tests may be selected, a “Location” box (FIG. 35, Item 4), and a “Table/Email” box (FIG. 35, Item 5). All of these are for selecting specific criteria for viewing on the log report. An “Update/ID” box (FIG. 35, Item 6) contains the names of users who have initiated changes. Also, a time frame for the log report is selected by selecting a “Log Start Date” and a “Log End Date” (FIG. 35, Item 7). After all of the required selections are made, the user clicks on the “OK” button (FIG. 35, Item 8) to compile the report.

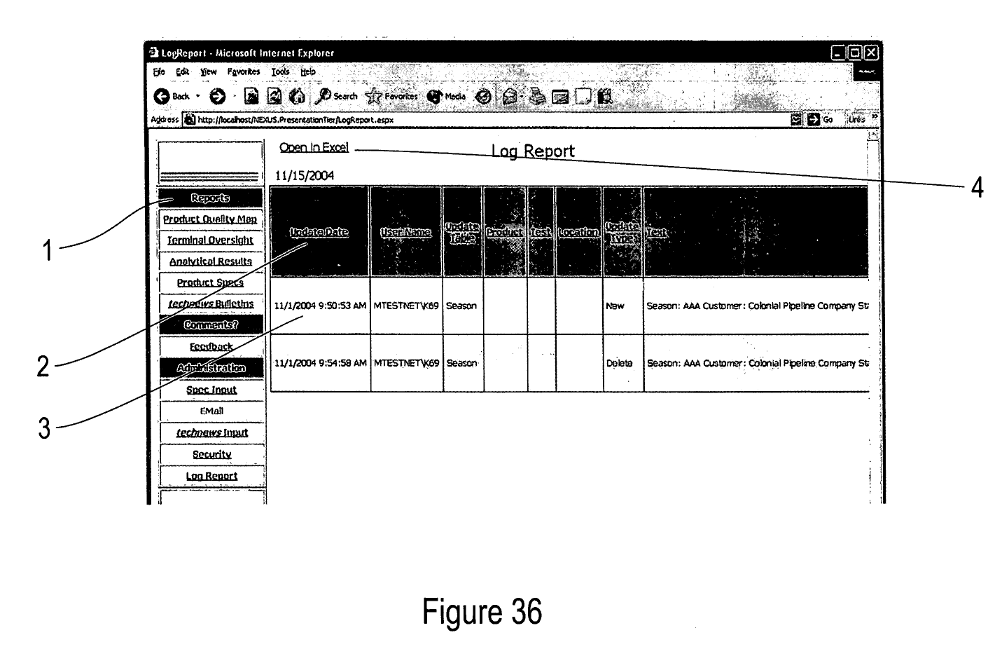

FIG. 36 shows an example of a completed log report that was compiled as a result of the selections made in FIG. 35. On the left side of the log report screen is the application's navigation bar (FIG. 36, Item 1). At the center of the log report is a table showing the log data. At the top of the table there are data field columns (FIG. 36, Item 2) showing “Update Date”, that is the date the record was updated, “User Name”, which is the user who updated the record, “Update Table”, which is the name of the database table that was updated, “Product”, “Test”, “Location”, “Update Type”, and “Text”. The rows of the table (FIG. 36, Item 3) contain data records showing the applicable modifications to the specification database. At the top of the report page is a hyperlink labeled “Open in Excel” which when clicked will open the same report in the Microsoft Excel spreadsheet format.

In addition to the automatic email notification system built into the application as shown in FIG. 30, the application also has an automated system which sends all affected parties an electronic mail notification 30 days prior to any specification changes and an additional email on the specification start effective date. The list of email recipients is obtained from the permissions and users list and consists of all users in the “Email Distribution List” group. The emails are also copied to all users in the “Administrative Assistant” group.

Refinery laboratory information systems (LIMS) are also updated automatically by the database application everyday. All product specifications with a specification effective date of the current day will be updated in the appropriate refinery laboratory information management system (LIMS) database.

The above description of the databases and software application is given for explanatory purposes. For those skilled in the art, it will be apparent that modifications may be made to the application dependent upon a user's specific needs without departing from the scope of the invention.

1. A software application system for use in a company-wide computer network for managing product specification data by interfacing with at least one centralized database.

2. The system of claim 1 wherein the at least one database includes data on at least one or more of the following: product specifications, product sample analysis results, and product naming and unit standards.

3. The system of claim 1 wherein all the data is related to petroleum products.

4. The system of claim 2 further having a graphical user interface for database input and database report generation.

5. The system of claim 2 further being accessible at all company locations by means of a company-wide intranet computer network.

6. The system of claim 2 further having automatic notification means for alerting all relevant operations in the company of a change in product specifications.

7. The system of claim 6 wherein the notification means also provides an automatic alert to relevant operations when a product sample fails to meet product specifications.

8. The system of claim 2 further having the ability to dynamically create company bulletins for internal use that include real time information about products and their specifications.

9. The system of claim 8 wherein the company bulletins are also dynamically created for customer use.

10. The system of claim 2 wherein the database includes product sample analysis results obtained from company laboratory quality control sampling.

11. The system of claim 10 wherein analytical data from multiple laboratories within the company is collected.

12. The system of claim 11 wherein the analytical data is viewed and traded in multiple formats.

13. The system of claim 12 further including comparing the data to product specification data.

14. The system of claim 13 wherein the data is viewed on a geographical basis and mapping is provided to show product at all relevant locations in the company.

15. The system of claim 14 wherein the data is further displayed to provide historical information for specific products and product specifications for specified ranges of dates.
